(19) United States
(12) Patent Application Publication
(10) Pub. No.: US 2019/0066028 A1
(43) Pub. Date: Feb. 28, 2019

(54) A METHOD AND SYSTEM FOR GENERATING AND DISPLAYING A PROJECT MANAGEMENT PLAN

(71) Applicant: PROJECT MAP LTD, Kfar Saba (IL)

(72) Inventor: Yaniv SHOR, Shoham (IL)

(73) Assignee: PROJECT MAP LTD., Kfar Saba (IL)

(21) Appl. No.: 16/084,539

(22) PCT Filed: Mar. 7, 2017
(86) PCT No.: PCT/IL2017/050292

§ 371 Date: Sep. 12, 2018

Related U.S. Application Data
(60) Provisional application No. 62/307,601, filed on Mar. 14, 2016.

(51) Int. Cl. G06Q 10/06; G06F 3/0482; G06F 3/0481; G06F 3/0484

(52) U.S. Cl. CPC G06Q 10/063118; G06F 3/04845; G06F 3/04817; G06F 3/0482

(57) ABSTRACT

A computer-implemented method and system for dynamically updating and displaying project management plan via a graphical user interface (GUI) including receiving via the GUI an indication regarding a project management granularity to be updated, whereby the granularity is selected from at least three different levels of detail presented to the user by the GUI, each of the levels is linked to a respective database, receiving a command via the GUI to add at least one activity in a time-slot in the indicated granularity, storing the at least one activity in the database respective to the indicated project management granularity, and displaying by the GUI, the project management plan in a layered configuration according to areas of activity along a timeline, whereby each layer of display denotes one of the project management levels of detail, thereby displaying the added at least one activity in the layer corresponding to the indicated granularity.

### FIELD OF THE INVENTION

The present disclosure generally relates to a method and system for generating a presentable project management plan.

### BACKGROUND

Project management software solutions provide functions for organizing project information, planning and scheduling, analysis, resource, budget, etc. These software applications typically provide an environment in which users can input, view and interact with information related to the project. For example, list tasks in some kind of hierarchical structure, assign task duration, mark dependencies, add milestones and calculate project duration and critical chain. The project planning can be visually represented in various ways including Gantt charts, PERT diagrams, etc., which are displayed to the users of the project management software application.

Planning and managing projects requires determining a timeframe, presentation structure, tasks to be completed, interaction and interdependencies between tasks, etc. Known techniques for presenting the project, timeframe, tasks, etc. include, for example, Microsoft MS Project software, which displays Gantt charts, PERT network diagrams, etc. of the project tasks in a production-line manner, in-line with the Gantt chart origin. This software and similar software applications are non-intuitive, require a substantial learning curve, and convey the project information in an inconvenient manner, thus making it difficult to see the big picture on one hand, and the detailed level on the other hand.

Project managers using management applications usually first organize the project using a whiteboard planning or action plan before entering data into the project management application. When the data is finally entered, a significant amount of intuitive planning information of structuring the project information is not insertable into the project management application due to the limitations of current project management applications. Moreover, a complete project plan structured through existing processes does not provide action planning, and in large projects that include a substantial number of tasks that take a lengthy amount of time, the scale and size of the Gantt/PERT charts is difficult to present in an efficient manner. Generating a project action plan and a risk plan is up to the project manager, and are performed separately from the project management application. The project manager relies on experience and/or the project team dynamics to identify crucial points and weaknesses that are likely to cause problems or delays in completion of the project. Presenting the project workflow further requires conversion into different types of diagrams or textual descriptions to enable third parties to understand the project plan.

Project management methods, such as using Gantt charts, use hierarchical task structures identified according to a task identification, e.g. task name, task identification number, etc. Such hierarchical task structure starts from high level tasks and may further detail low level tasks with layers of tasks in between. A traditional project management software user may generate a detailed set of tasks, which is a detailed definition of a higher level task, or generate a set of tasks relating to areas of activity, which are also captured as task description. The presentation of project plans in current systems cannot present both the higher level tasks and detailed areas of activity due to the limitations of presentation space of the traditional project management software applications.

There is thus the need for a new project management software application that may generate an easy to follow display of a project or a plurality of projects, including all task levels.

### SUMMARY

According to an aspect of some embodiments of the present invention there is provided a computer-implemented method for dynamically updating and displaying project management plan via a graphical user interface (GUI), the method including: receiving via the GUI an indication regarding a project management granularity to be updated, whereby the granularity is selected from at least three different levels of detail presented to the user by the GUI, whereby each of the levels is linked to a respective database; receiving a command via the GUI to add at least one activity in a time-slot in the indicated granularity; storing the at least one activity in the database respective to the indicated project management granularity; and displaying by the GUI, on a screen of a computerized device, the project management plan in a layered configuration according to areas of activity along a timeline, whereby each layer of display denotes one of said project management levels of detail, thereby displaying the added at least one activity in the layer corresponding to the indicated granularity.

According to some embodiments, in case the indicated granularity is not the smallest, the method comprises updating at least one database respective to a smaller granularity level according to the added activity.

According to some embodiments, in case the indicated granularity is not the smallest, the method comprises displaying the at least one activity in at least one layer respective to a smaller granularity.

According to some embodiments, the project management levels of detail comprise at least the following levels: Details, Planning, and High-level.

In some embodiments, the activities include information selected from: activity name, activity description, start and end time, cost, person assigned to accomplish the activity, risk level, changing activity to a buffer activity, or any combination thereof.

According to some embodiments, the method includes adding links between activities, such that between a first activity linked to a second activity, the second activity begins or ends once the first activity begins or ends. According to some embodiments, the links are added between activities in the same area of activity, or between activities in different areas of activity. The number of links between activities may define the project's structure.

In some embodiments, the method further includes adding milestones along the timeline of the display. Optionally, the milestones include information selected from: milestone name, milestone description, date, or any combination thereof.

In some embodiments, the method includes assigning risk levels to any of the activities of any of the project management levels of detail.

In some embodiments, the method further includes removing or updating activities in any of the project management levels of detail, thereby updating the corresponding activities or sub-activities in the other levels.

According to some embodiments, the timeline grid is configurable between days, weeks, months, yearly quarters, and years.

According to some embodiments, each of the layers of display includes all areas of activity relevant to the project management plan, thus providing a single screen display per each of the layers.

In some embodiments, the method further includes generating and displaying a specific employee's view, which includes a display of activities per project along the timeline that the specific employee or a manager has indicated to be assigned to the employee. In some embodiments, the specific employee view includes information selected from: activity name, activity description, start and end time, costs, risk level, status of an activity, percentage of accomplishment of an activity, or any combination thereof.

According to another aspect of some embodiments of the present invention there is provided a system for dynamically updating and displaying project management plan via a graphical user interface (GUI), the system including: at least one computerized device comprising a screen and a GUI on the screen, and a plurality of databases, each linked to a respective different project management granularity. The system may further include at least one processor configured to execute a code, the code comprising instructions for: receiving via the GUI an indication regarding a project management granularity to be updated, the granularity is selected from at least three different levels of detail presented to the user by the GUI; receiving a command via the GUI to add at least one activity in a time-slot in the indicated granularity; storing the at least one activity in a database respective to the indicated project management granularity; and displaying by the GUI, the project management plan in a layered configuration according to areas of activity along a timeline, wherein each layer of display denotes one of the project management levels of detail, thereby displaying said added at least one activity in the layer corresponding to the indicated granularity.

According to some embodiments, in case the indicated granularity is not the smallest, the code's instructions comprise updating at least one database respective to a smaller granularity according to the added activity.

According to yet another aspect of some embodiments of the present invention, there is provided a computer-implemented method for dynamically updating and displaying project management plan via a graphical user interface (GUI), the method including: receiving via the GUI an indication regarding a project management granularity to be updated, the granularity selected from at least three different levels of detail presented to the user by the GUI, whereby each of the levels of detail is linked to a respective database; receiving a command via the GUI to add at least one link between at least two different activities in the indicated granularity, whereby each of the at least two activities relate to a different area of activity; storing the at least one link in the database respective to the indicated project management granularity; and displaying by the GUI, on a screen of a computerized device, a project management plan according to areas of activity along a timeline comprising at least one link between activities related to different areas of activities, thereby displaying at least one risk of the project management plan.

In some embodiments, the method may include calculating an engagement rate, wherein the engagement rate is calculated per a single activity, per activities under the same area of activity or per total activities under a single project. According to some embodiments, the engagement rate is calculated based on indications received via the GUI regarding an employee's progress in accomplishing a single activity, activities under the same area of activity, or total activities under a single project. According to some embodiments, the engagement rate may be calculated based on message traffic per a single project. That is, the amount of engagement of all or some of the employees relevant to accomplishing a certain project caused by messages sent between these employees, may be used to determine the engagement rate per that project.

In some embodiments, the method includes calculating a confidence level per a single activity, per activities under the same area of activity, or per total activities under a single project. For example, the confidence level is calculated based on number of links connected to a specific activity.

### BRIEF DESCRIPTION OF THE DRAWINGS

Some exemplary non-limiting embodiments or features of the disclosed subject matter are illustrated in the following drawings.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views. References to previously presented elements are implied without necessarily further citing the drawing or description in which they appear.

FIG. 1A schematically illustrates a system for generating a project management plan, a risk reduction plan and related reports, according to embodiments of the present invention;

FIG. 1B is a schematic flow chart describing a method for dynamically updating and displaying project management plan via a graphical user interface (GUI), according to embodiments of the present invention;

FIG. 1C is a schematic flow chart describing a method for dynamically updating and displaying project management plan via a GUI, according to other embodiments of the present invention;

FIG. 2 schematically illustrates a user interface configured for adding an activity into a project management plan, according to embodiments of the present invention;

FIGS. 3A-3B are schematic flow charts describing methods for adding a link between activities of the same area of activity, to a project management plan, and for removing a link between activities of the same area of activity, from a project management plan, respectively, according to embodiments of the present invention;

FIGS. 4A-4B are schematic flow charts describing method for adding a link between activities of different areas of activity, to a project management plan, and for removing a link between activities of different areas of activity from a project management plan, respectively, according to embodiments of the present invention;

FIGS. 5A-5B schematically illustrate a user interface configured for adding and removing a link between activities, respectively, along a project management plan, according to embodiments of the present invention;

FIGS. 6A-6D are schematic flow charts describing methods for adding activity on one level of detail and how this affects other levels of details of the project management plan, according to embodiments of the present invention;

FIG. 7A schematically illustrates a user interface displaying a graphic representation of a project management plan of a first granularity, according to embodiments of the present invention;

FIGS. 7B-7C schematically illustrate a user interface displaying a graphic representation of a project management plan of a second granularity, according to embodiments of the present invention;

FIG. 7D schematically illustrates a user interface displaying a graphic representation of a project management plan of a third granularity, according to embodiments of the present invention;

FIG. 8 schematically illustrates a user interface displaying a graphic representation of critical tasks in a project management plan of a first granularity, according to embodiments of the present invention;

FIG. 9 schematically illustrates a user interface displaying a graphic representation of indicators per project of a project portfolio management, according to embodiments of the present invention;

FIG. 10 schematically illustrates a user interface displaying a graphic representation of a project management plan including a message to owner of the project plan, according to embodiments of the present invention;

FIG. 11 schematically illustrates a user interface displaying a graphic representation of a project management plan including messages to members of the team that are to accomplish the project, in order to establish collaboration between the team members, according to embodiments of the present invention;

FIGS. 12A-12B schematically illustrate a user interface displaying a graphic representation of a project management plan including engagement rate per area of activity and confidence level per area of activity, and total activities and open activities, respectively, according to embodiments of the present invention;

FIG. 13 schematically illustrates a risk plan, according to embodiments of the present invention;

FIGS. 14A-14B schematically illustrate a user interface displaying a graphic representation of team member view of the member's pending projects, according to embodiments of the present invention;

FIG. 15 schematically illustrates a user interface displaying a graphic representation of a project management plan of a second granularity level including among others engagement and confidence levels, and risk avoidance level, according to embodiments of the present invention;

FIGS. 16A-16B are schematic flow charts describing methods for changing existing activity duration, according to embodiments of the present invention;

FIG. 17 schematically illustrates different expansion states of the user interface, according to embodiments of the present invention;

FIGS. 18A-18C schematically illustrate methods for generating and displaying a project action plan, according to embodiments of the disclosed subject matter;

FIG. 19 schematically shows a project action plan data structure, according to embodiments of the subject matter;

FIGS. 20A-20E schematically show a user interface displaying a graphic representing of a project action plan, according to embodiments of the subject matter;

FIG. 21 schematically shows a user interface displaying a project statistics report representation, according to embodiments of the subject matter; and

FIG. 22 schematically shows a coordination plan, according to embodiments of the subject matter.

### DETAILED DESCRIPTION

One technical problem dealt by the disclosed subject matter is providing an action plan that presents all aspects of a project from beginning to end, while being presentable and providing assistance in optimizing the oversight of the action plan.

One technical solution according to the disclosed subject matter is a system and method for collecting project data so as to enable automatic extraction of an action plan and risk management. The action plan and risk management are generated and provided in a presentable and user friendly manner. The solution provides for obtaining project related areas of activities, activities and tasks to be performed for completion of the project, critical dependencies, and perceived risk to generate a project analysis. The project analysis enables management of the action plan and an associated risk reduction plan. The action plan and risk reduction plan are managed according to the system and method disclosed herein to provide a complete coverage and risk management of potential project risks and pitfalls, based on the collected data. The system and method enable sharing of the action plan to enable multiple users to provide collected data for providing the most efficient and reliable action plan.

Some embodiments of the present invention provide a system and method for dynamically updating and displaying a project management plan via a graphical user interface (GUI). The project management plan may be displayed in a layered configuration according to granularity levels, and according to area of activity or the various activities that are displayed and added (or removed) from the GUI of the project management plan.

As explained above, current project management methods are limited in space and thus may not display all granularity and all areas of activity in one screen, whereas the present invention enables such a detailed display providing all relevant details per each granularity, per each area of activity, along with the ability to change the display from one granularity level to another. Furthermore, the pending invention provides a dynamic display such to enable display of a plurality of projects per owner, and such to display a list of projects per any team member of the team that is to accomplish any of the pending projects.

In addition, the present invention enables adding and removing links between activities, whether within the same area of activity, or within different areas of activity. Such links may denote the dependency between activities, as well as enable to determine the risks present along the project management plan, since typically, the links between activities from different areas of activity represent the most problematic tasks, as these represent transitions from one area of activity to another. Thus, such links provide information regarding risks along the project management plan, in a visual and easy to understand manner.

As used herein, the term “granularity” refers to level of details that a certain project management level contains. The greater the granularity, the deeper the level of detail.

Some embodiments of the present invention may include a system, a method, and/or a computer program product. The computer program product may include a tangible non-transitory computer readable storage medium (or media) having computer readable program instructions thereon for causing a processor to carry out aspects of the present invention. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

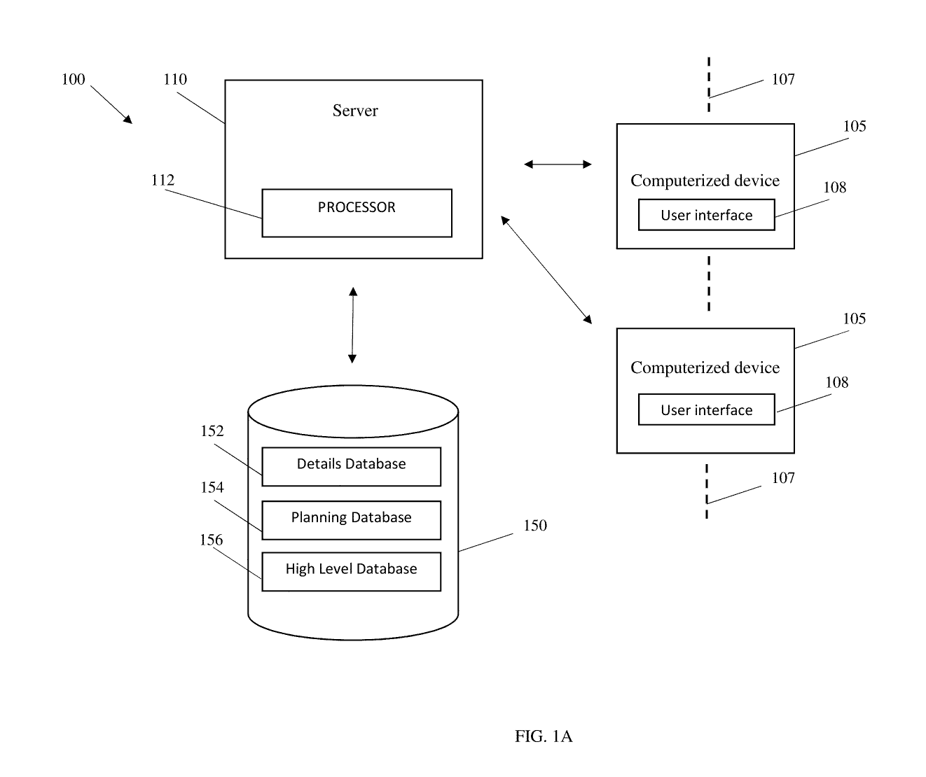

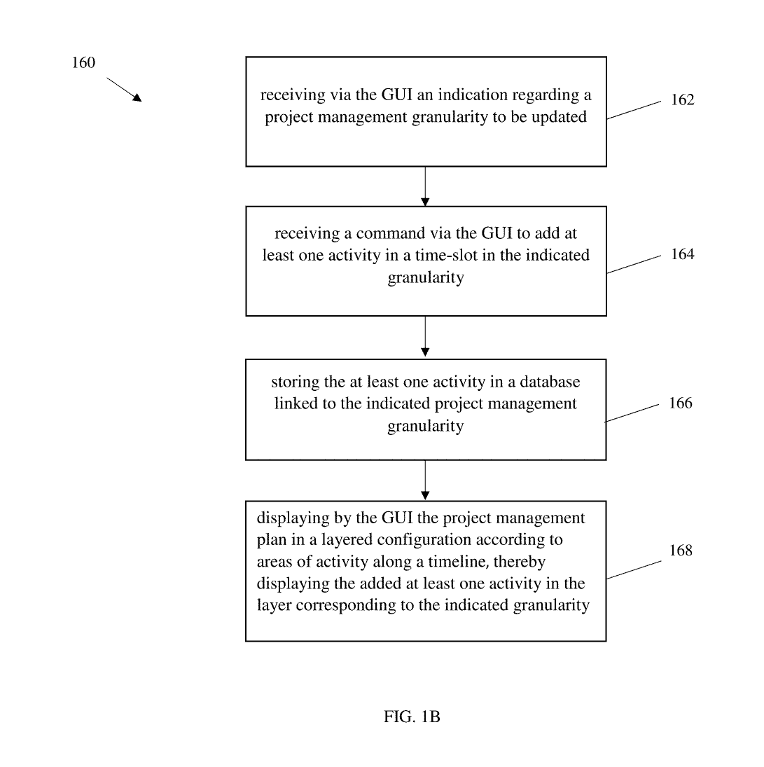

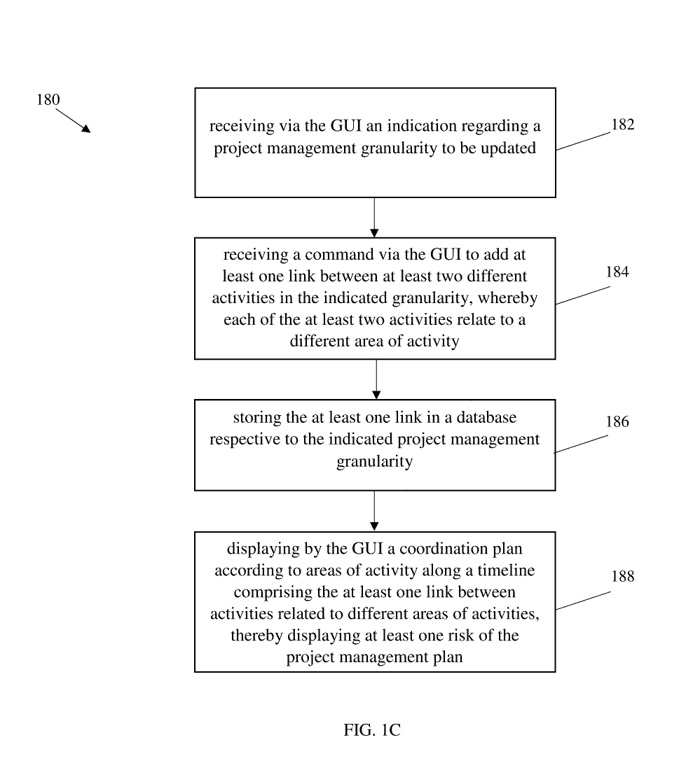

Reference is now made to FIG. 1A, which schematically illustrates a system 100 for generating a project management plan, a risk reduction plan and related reports, according to embodiments of the present invention.

System 100 may comprise one or more user computer device 105, illustrated in FIG. 1A by two user computer devices 105. User computer device 105 may include any number of user computer devices 105 or just one user computer device 105, represented by the dotted lines 107. User computer device 105 may obtain data used to generate the project plan from a user. In some embodiments, user computer device 105 may be a smartphone, tablet, laptop, desktop, or the like. User computer device 105 may comprise a graphical user interface (GUI) 108, which may provide a user of user computer device 105 an interface via which a user may create a project plan, for example by entering data used by computer device 105 to generate the project action plan, project risk reduction plan, and related reports, and via which information is displayed to the user. User computer device 105 may communicate with project server 110, either wirelessly or via wires. Project server 110 may include or communicate with at least one hardware processor 112, which may execute various modules, e.g. software components including machine code instructions, in order to generate a project management plan according to data obtained from user computer device 105. For example, processor 112 may execute any of the following modules: a “Project Plan” module, “Action Plan” module, “Risk Reduction Plan” module, “Resources Analysis” module, “Budget Calculation” module, a “Setup and Configuration” module, or any other module that may enable processing of data and generating a thorough and easy to understand project management plan presentation. In some embodiments, project server 110 may include, control and/or communicate with a database 150, which may store the data related to the projects created by users, e.g., activities, links between activities, milestones, etc. According to some embodiments, the processor 112 may execute a code comprising instructions for generating a project management plan, and the code instructions may cause the processor to carry out the methods described herein.

GUI 108 may be configured to present to a user various optional levels of details or various optional granularity from which the user may select, in order to insert project information in the selected level of detail. For example, the most detailed level of the project management plan may be called ‘Details’. The ‘Details’ level is the level of greatest granularity. The level with least details may be called ‘High Level’, and this level may be of smallest granularity. The project management level of medium or intermediate granularity may be called ‘Planning’. In other embodiments, other numbers and other names of optional levels of details may be implemented.

According to some embodiments, database 150 may be divided to or may comprise more than one database, such that each level of detail of the project management plan may be linked to its respective database. For example, the most detailed level of the project management, e.g., the level called ‘Details’ may be linked to a respective database 152 called ‘Details database’. Similarly, the project management level of medium granularity called ‘Planning’ may be linked to a respective database 154 called ‘Planning database’, and the project management level of smallest granularity called ‘High Level’ may be linked to a respective database 156 called ‘High Level database’.

During operation, processor 112 may receive via GUI 108 an indication regarding a selected project management granularity to be updated, wherein the granularity may be selected from at least three different levels of detail (e.g., ‘Details’, ‘Planning’, and ‘High Level’) presented to the user by GUI 108. Processor 112 may further receive a command via GUI 108 to add at least one activity in a time-slot in the indicated granularity, which may be part of the entire project management plan.

In some embodiments, the at least one added activity may be stored in a database respective to the indicated project management granularity (for example, if the project management level is of medium granularity, e.g., ‘Planning’ level, then the respective database would be Planning database 154). GUI 108 may then display the project management plan in a layered configuration, such that each layer of display may denote one of the project management levels of detail, according to areas of activity along a timeline. That is, GUI 108 may display the added at least one activity in the layer corresponding to the indicated granularity (e.g., Planning level, though any other granularity may be applied).

Reference is now made to FIG. 1B, which is a schematic flow chart describing a method 160 for dynamically updating and displaying project management plan via a graphical user interface (GUI), according to embodiments of the present invention. According to some embodiments, method 160 may comprise receiving via the GUI an indication regarding a project management granularity to be updated, as indicated in block 162. Typically, the processor, e.g., processor 112 (FIG. 1A) may receive such an indication via the GUI, e.g., GUI 108 (FIG. 1A). In some embodiments, method 160 may further comprise receiving a command via the GUI to add at least one activity in a time-slot in the indicated granularity, as indicated in block 164. Typically the processor may receive the command via the GUI.

In some embodiments, method 160 may comprise storing the at least one activity in a database linked to the indicated project management granularity, as indicated in block 166. According to some embodiments, and as mentioned with respect to FIG. 1A, database 150 may be divided to or may comprise more than one database, such that each level of detail of the project management plan may be linked to its respective database, e.g., databases 152, 154 and 156. Thus, any activity may be stored in the database linked to a specific project management granularity, which may be selected from several optional granularity levels or several levels of details. For example, if an activity is added to the level of greatest granularity, e.g., ‘Details’ level, the activity may be stored in database 152, which is the ‘Details database’ that is linked to the ‘Details’ level of granularity. Similarly, any added activity may be stored in a database corresponding to the level of granularity to which the activity was added.

In some embodiments, method 160 may further comprise displaying by the GUI, the project management plan in a layered configuration according to areas of activity along a timeline, thereby displaying the added at least one activity in the layer corresponding to the indicated granularity, as indicated in block 168. In some embodiments, the GUI may display the project management in a layered configuration, such that the actual layer entirely displayed on a screen of a computerized device may be selected via the GUI. Once a specific layer of the project management plan is selected, any activity added onto that layer may also be displayed via the GUI.

Reference is now made to FIG. 1C, which is a schematic flow chart describing a method 180 for dynamically updating and displaying project management plan via a GUI, according to other embodiments of the present invention. According to some embodiments, method 180 may comprise receiving via the GUI an indication regarding a project management granularity to be updated, as indicated in block 182. Typically, the processor, e.g., processor 112 (FIG. 1A) may receive such an indication via the GUI, e.g., GUI 108 (FIG. 1A). In some embodiments, method 180 may further comprise receiving a command via the GUI to add at least one link between at least two different activities in the indicated granularity, whereby each of the at least two activities relate to a different area of activity, or to a different sub-area of activity, as indicated in block 184. Typically the processor may receive the command via the GUI.

In some embodiments, method 180 may comprise storing the at least one link in a database linked to the indicated project management granularity, as indicated in block 186. According to some embodiments, and as mentioned with respect to FIG. 1A, database 150 may be divided to or may comprise more than one database, such that each level of detail of the project management plan may be linked to its respective database, e.g., databases 152, 154 and 156. Thus, any activity may be stored in the database linked to a specific project management granularity, which may be selected from several optional granularity levels or several levels of details. For example, if a link is added to the level of medium granularity, e.g., ‘Planning’ level, the activity may be stored in database 154, which is the ‘Planning database’ that is linked to the ‘Planning’ level of granularity. Similarly, any added link may be stored in a database corresponding to the level of granularity to which the link was added.

In some embodiments, method 180 may further comprise displaying by the GUI a project management plan according to areas of activity along a timeline comprising the at least one link between activities that relate to different areas of activities, thereby displaying at least one risk of the project management plan, as indicated in block 188. In some embodiments, the GUI may display the project management in a layered configuration, such that the actual layer entirely displayed on a screen of a computerized device may be selected via the GUI. Once a specific layer of the project management plan is selected, any link added onto that layer between activities that relate to different areas of activity or relate to different sub-areas of activity may also be displayed via the GUI.

According to some embodiments, a link between activities of different sub-areas of activity or of different areas of activity indicate that there is a risk, since when activities of different areas of activity (or different sub-areas of activity) are connected, this indicates dependency between these activities of different areas of activity. Dependency between activities of different areas of activity may mean that specific notice should be addressed in order to ensure that these activities are both accomplished properly. Specifically, that once a first activity ends, the second begins with no interruptions, thus ensuring the entire project continues as planned.

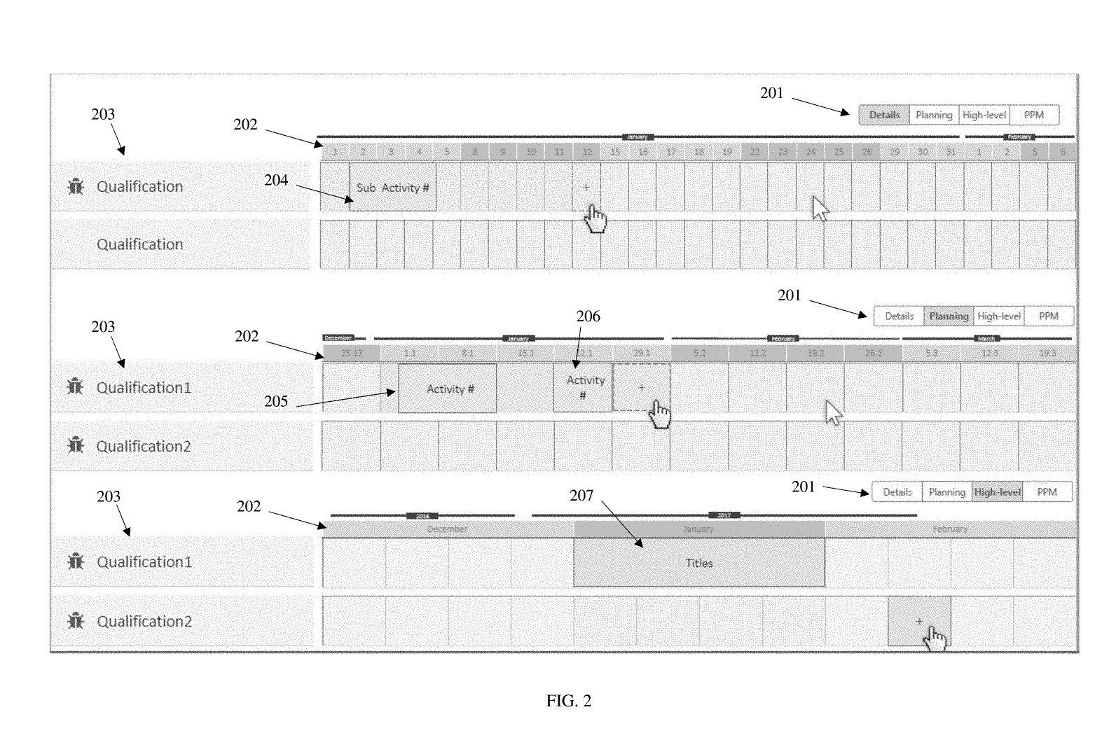

Reference is now made to FIG. 2, which schematically illustrates a user interface configured for adding an activity into a project management plan, according to embodiments of the present invention. The GUI may comprise a layered configuration, that is, the user may determine which of the project management levels of which granularity may be displayed on the main screen, while having the option to easily switch between all levels. In some embodiments, box 201 provides the possibility to select between the different granularity of the project management levels. For example, on GUI 210, box 201 is selected such that the project management level of the greatest granularity is displayed, e.g., the Details level is selected. On GUI 220 the Planning level (which is the level with medium granularity) is selected and on GUI 230 the High Level (which is the level with smallest granularity) is selected.

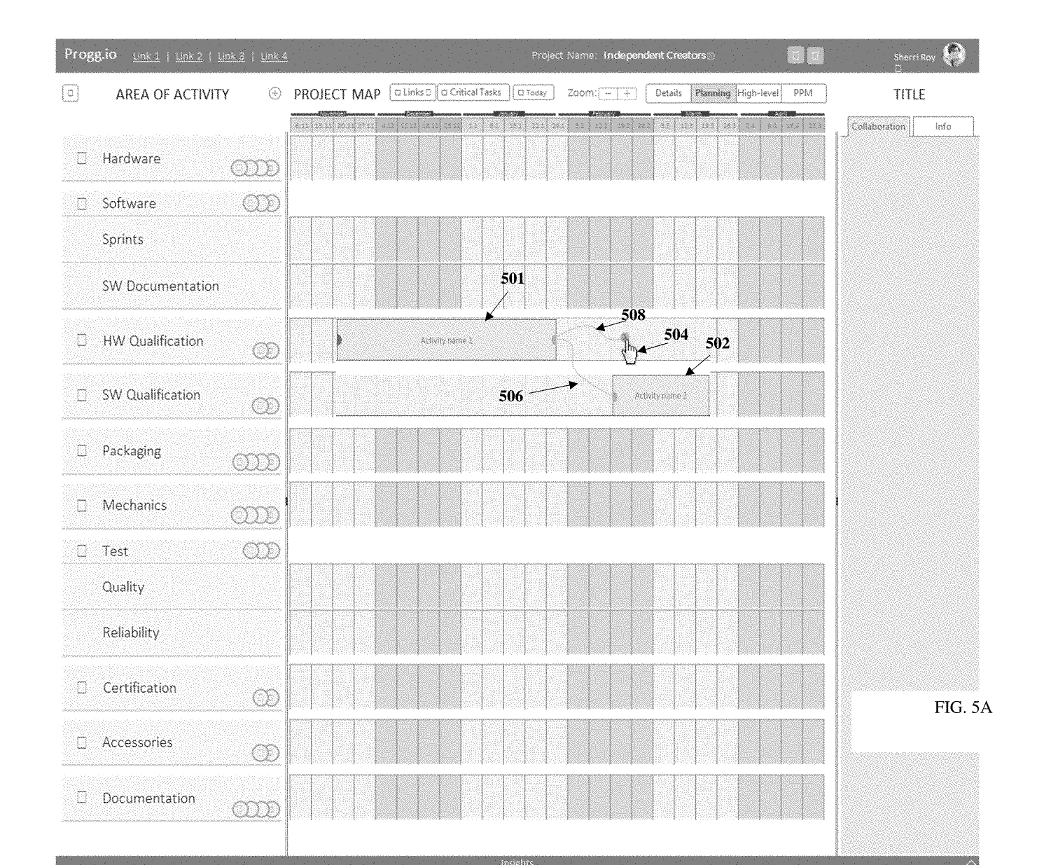

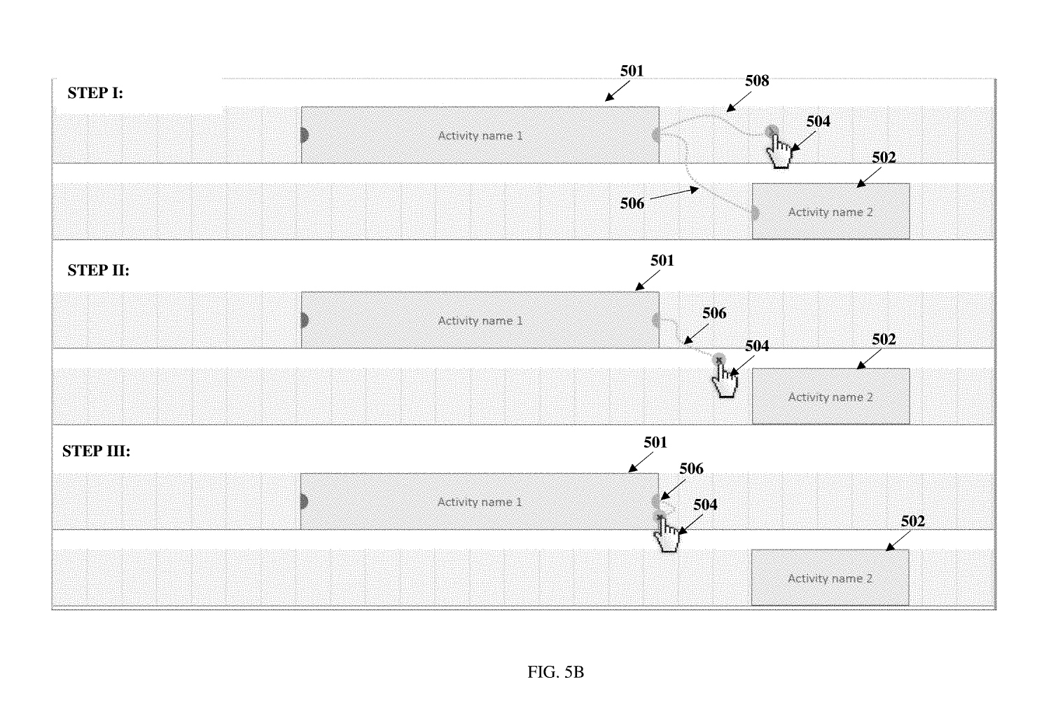

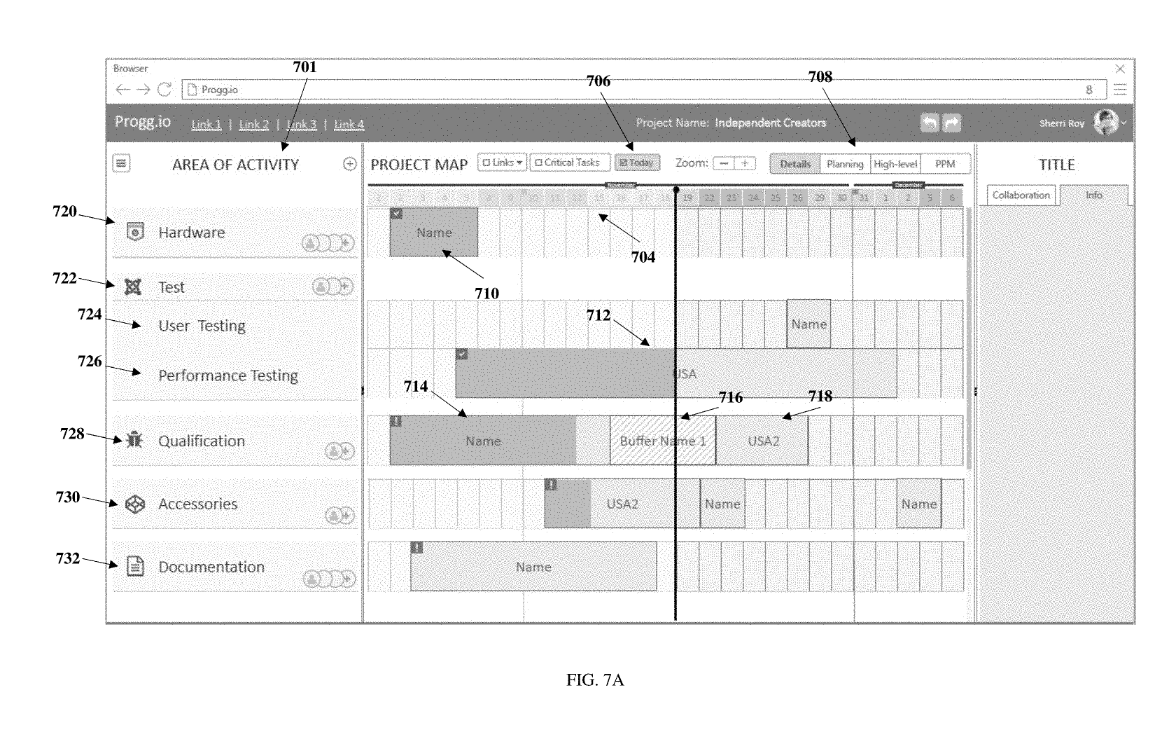

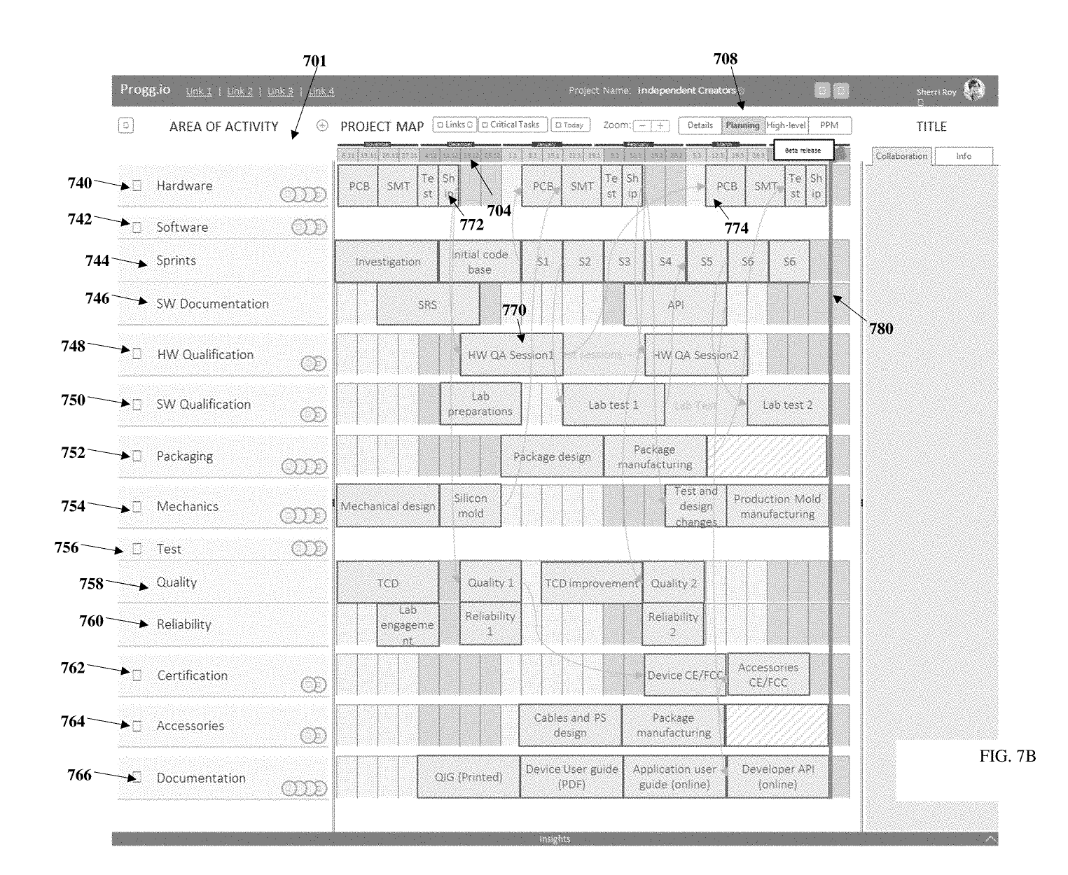

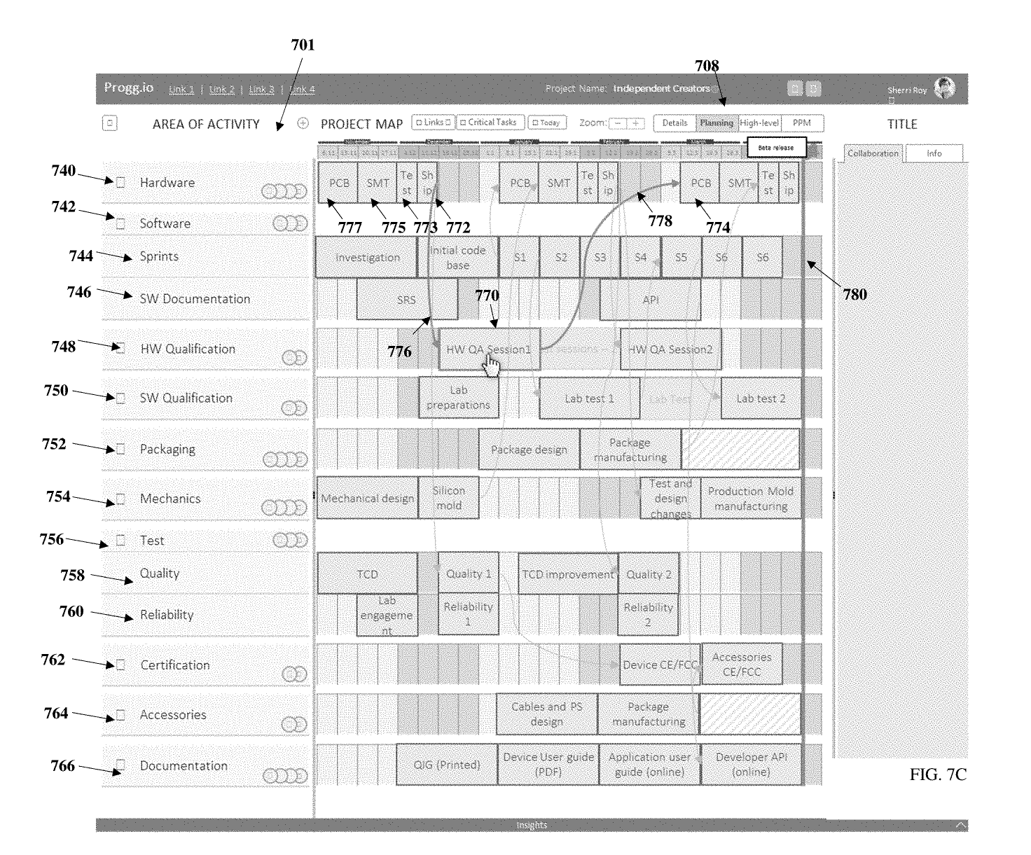

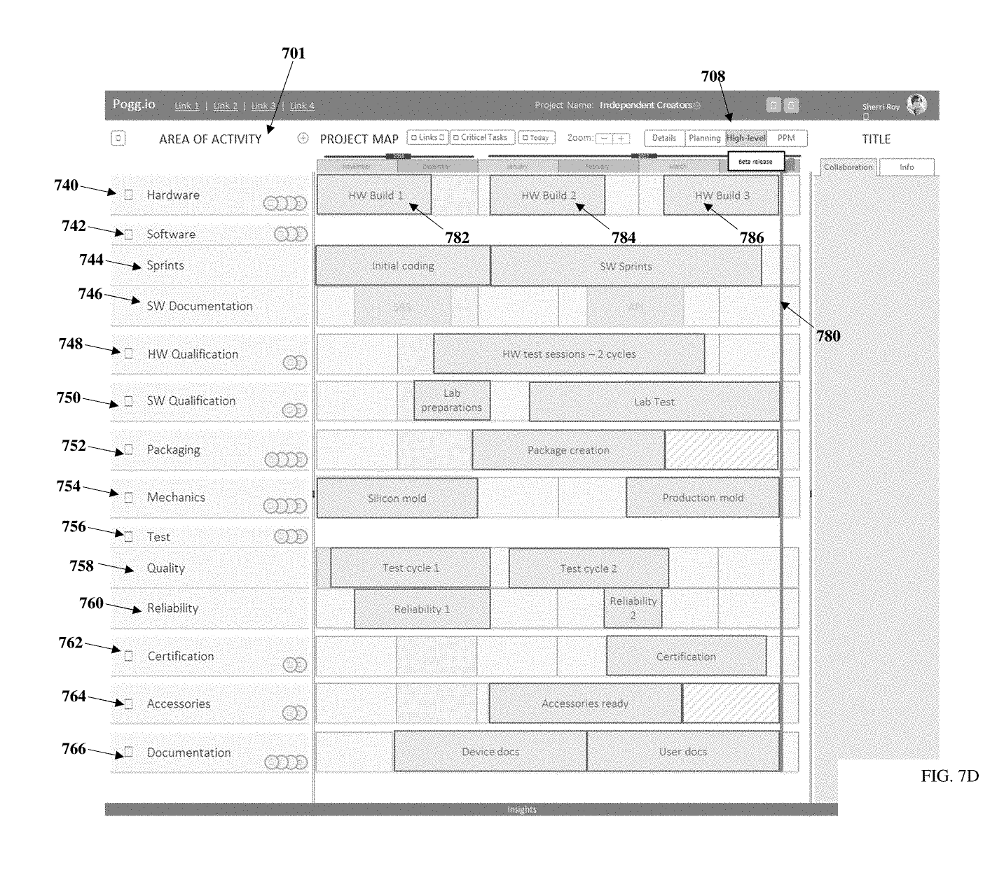

According to some embodiments, boxes 203 may indicate an area of activity corresponding to the activity that is to be added on the GUI. For example, an area of activity may be an element of the GUI that represents a certain activity subject or type of activities. Various areas of activity may be included in a project management plan. Specific examples will be provided with respect to following figures (e.g., FIGS. 5A, 7A, etc.).

In some embodiments, box 202 may indicate a timeline along which activities may be added to the project management plan. The timeline 202 may be displayed in different time scale levels, e.g., days, weeks, months, quarters and years, for example according to the selected granularity level. For example, timeline 202 in GUI 210 may display activities in a time scale of days, GUI 220 may display timeline 202 in a time scale of weeks, and GUI 230 may display timeline 202 in a time scale of months. Any other time scale may be displayed.

According to some embodiments, an activity may be added by clicking on the timeline 202, by placing a cursor on timeline 202, or by any equivalent way. The duration of an activity may be defined by the number of boxes along timeline 202 that are selected by the user. For example, in GUI 210, an activity 204 may be added along timeline 202, which is in the scale of days. The duration of activity 204 may be defined along timeline 202 by the user adding the activity. The number of boxes selected by the user along timeline 202 defines the duration of activity 204, or any other activity for that matter. In this example, activity 204 is defined to extend along 3 days. In some embodiments, activity 204 may be named a sub-activity, if and when such activity is added on the project management level of the greatest granularity.

In GUI 220, activities 205 and 206 may be added. There need not be any linkage, dependency or relationship between such activities. In this example, activity 205 may extend for a little less than two weeks, while activity 206 may extend for only a week. In GUI 230, activity 207, may extend for a month (e.g., the month of January). Any other number of activities and any other durations per activity may be added and defined by the user.

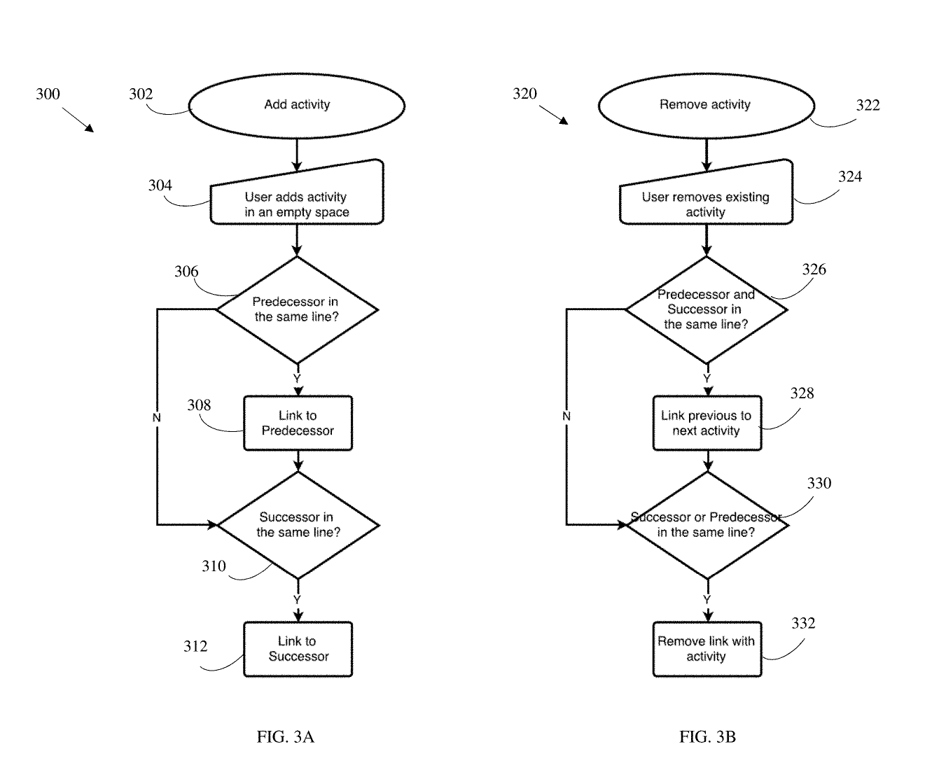

Reference is now made to FIGS. 3A-3B, which are schematic flowcharts illustrating methods 300 and 320 for generating a project plan, according to some embodiments of the present invention. According to some embodiments of the present invention, system 100 may be configured to enable adding a link between activities of the same area of activity, on a project management plan and removing a link between activities of the same area of activity, from a project management plan, respectively. The flowchart in FIG. 3A schematically illustrates a method 300 for adding a link between activities of the same area of activity, on a project management plan. As indicated in block 302 a processor, e.g., processor 112, may receive a command via the GUI (e.g., GUI 108) to add an activity to the project management plan. As indicated in block 304, which may indicate a manual operation, the activity may be added in an empty space along the project management plan. as indicated in block 306, the processor may determine whether a predecessor activity is in the same line as the newly added activity, i.e., whether a predecessor activity is from the same area of activity as the newly added activity, since activities of the same area of activity are typically displayed along the same line of the project management plan. If a predecessor is in the same line as the added activity (e.g., activity 205, FIG. 2), a link between the added activity and the predecessor activity may be added, as indicated in block 308. If a predecessor activity is not in the same line as the added activity, or following adding a link between the added activity and a predecessor activity as indicated in block 308, it may be determined by the processor whether a successor activity is in the same line as the added activity, as indicated in block 310. If so, a link may be added between the added activity and the successor activity, as indicated in block 312.

FIG. 3B schematically illustrates a method 320 for removing a link between activities of the same area of activity, from a project management plan. As indicated in block 322 a processor may receive a command via the GUI to remove an activity from the project management plan. As indicated in block 324, an existing activity may be removed from the project management plan. As indicated in block 326, the processor may determine whether a predecessor activity and a successor activity are in the same line as was the removed activity, i.e., whether a predecessor activity and a successor activity are from the same area of activity as was the removed activity, since activities of the same area of activity are typically displayed along the same line of the project management plan. If a predecessor and successor are in the same line as was the removed activity, then a link may be amended such to link between a predecessor activity to the next activity, e.g., the successor activity, instead of linking between the removed activity to both the predecessor and the successor activities, as indicated in block 328. If the predecessor and successor are not in the same line, or following amendment of the link corresponding to the removed activity, a processor may determine whether only a predecessor activity or a successor activity are in the same line as was the removed activity, as indicated in block 330. If only the predecessor activity or the predecessor activity are indeed in the same line as was the removed activity, the link that was linking between the predecessor activity and the removed activity, or the link that was linking between the successor and the removed activity, may be removed along with the removed activity, as indicated in block 332.

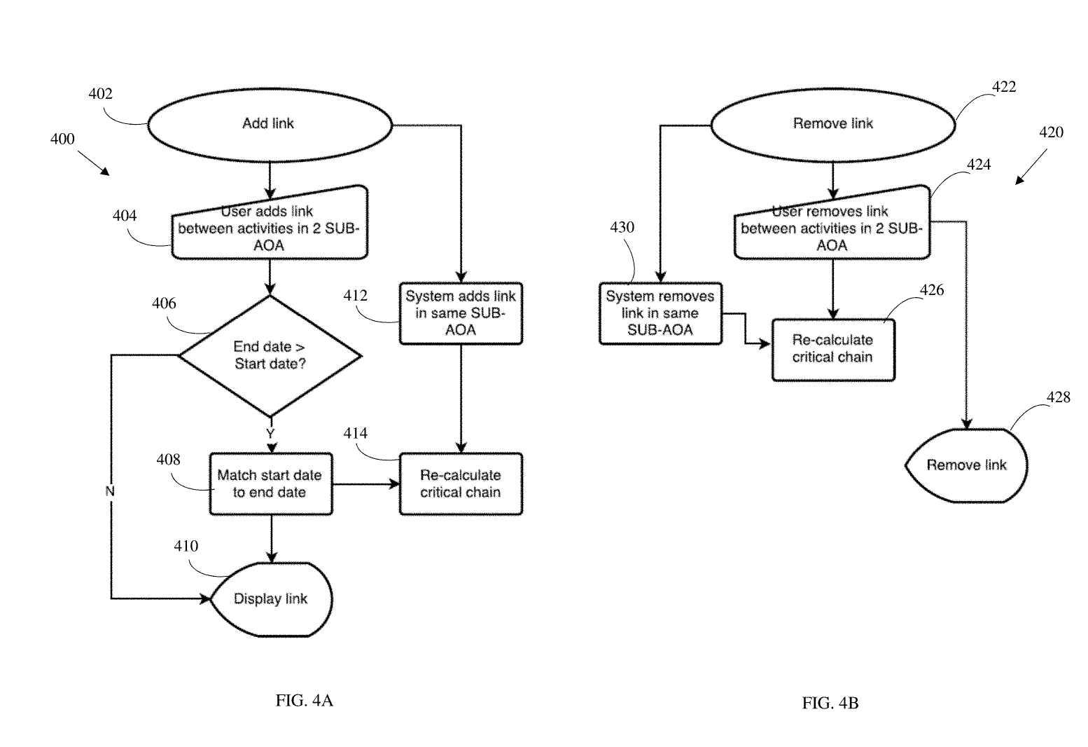

Reference is now made to FIGS. 4A-4B, which are schematic flowcharts illustrating methods 400 and 420 for generating a project plan, according to some embodiments of the present invention. According to some embodiments of the present invention, system 100 may be configured to enable adding a link between activities of different areas of activities on a project management plan, and removing a link between activities of different areas of activities from a project management plan, respectively, according to embodiments of the present invention. FIG. 4A schematically illustrates a method 400 for adding a link between activities of different areas of activities (AOA) on a project management plan, according to some embodiments. As indicated in block 402, the processor may receive a command via the GUI to add a link between a first activity and a second activity in two different sub-areas of activity, e.g., each of the linked activities corresponds to a different area of activity, as indicated in block 404. As indicated in block 406 the processor may determine whether the end date of the first activity is after the start date of the second activity. If the end date of the first activity is not after the start date of the second activity, then as indicated in block 410, the link may be displayed as part of the project management plan. If the end date of the first activity is indeed after the start date of the second activity, then as indicated in block 408, the start date of the second activity may be amended such to match the end date of the first activity. As indicated in block 414, following match of the start date of the second activity to the end date of the first activity, the critical chain of the activities within the project management plan may be re-calculated. In some embodiments, the critical chain may be defined as the shortest route to the end of the project, which may be calculated based on activities duration and dependencies between activities.

In some embodiments, the processor receiving a command via the GUI to add a link between activities, as indicated in block 402, may mean that the processor may receive a command to add a link between activities in the same sub-AOA, e.g., between activities of the same area of activity, as indicated in block 412 (and as described with respect to FIG. 3A). Following addition of a link between activities of the same AOA, as indicated in block 412, the processor may re-calculate the critical chain of the project management plan.

Reference is now made to FIG. 4B, which schematically illustrates a method 420 for removing a link between previously linked activities of different areas of activities (AOA) from a project management plan, according to some embodiments. As indicated in block 422, the processor may receive a command via the GUI to remove a link between activities. Receiving a command to remove a link between activities may be to remove a link between activities of the same AOA by the system, as indicated in block 430, or it may include removing a link between activities of different AOAs by a user, as indicated in block 424. Following a processor removing a link between activities of the same AOA, as indicated in block 430, the critical chain may be recalculated as indicated in block 426. In some embodiments, following removal of a link between activities of different AOAs, as indicated in block 424, the critical chain may be re-calculated as indicated in block 426. In addition, following removal of the link, as indicated in block 424, the link may be removed from display of the project management plan, e.g., may be removed from the GUI, as indicated in block 428.

Reference is now made to FIGS. 5A-5B, which schematically illustrate a user interface configured for adding and removing a link between activities, respectively, along a project management plan, according to embodiments of the present invention. FIG. 5A illustrates a user interface allowing a user to add a link between two activities, e.g., between activity 501 and activity 502. In some embodiments, activity 501 may be from the same AOA as activity 502, while in other embodiments, as illustrated in FIG. 5A, activity 501 is of a different AOA than the AOA of activity 502. For example, activity 502 may correspond to a first AOA of Hardware Qualification, while activity 502 may correspond to a second different AOA of Software Qualification. Any other activities of at least two different AOAs may be linked via link 506. A link, e.g., link 506 may be typically illustrated by a line connecting the end point of activity 501 to the start point of activity 502, assuming activity 502 starts after activity 501 ends.

In some embodiments, a cursor, e.g., cursor 504, may be controlled by a user in order to add such a link as link 506 between activities, e.g., activities 501 and 502. In some embodiments, a single activity may be linked to more than one other activity. Thus, an additional link, e.g., link 508 may be added between two other activities, e.g., between activity 501 and any other activity of the project management plan.

FIG. 5B schematically illustrates a user interface enabling a user or system to delete or remove a link between at least two activities. Following step I, which illustrates adding a link between two activities, e.g., activity 501 and activity 502 (described in detail with respect to FIG. 5A), step II illustrates a user removing a link between two activities, e.g., activity 501 and activity 502. A user may control cursor 504 such to click and/or drag the end of link 506 which was previously connected to the start point of activity 502, towards activity 501. In step III, the cursor may further be dragged towards activity 501 till cursor 504 reaches the start point of link 506, which was at the end point of activity 501, thus removing or deleting link 506 from the project management plan, and un-linking activity 502 from activity 501. Any other user interface method may be applied in order to perform such link removal.

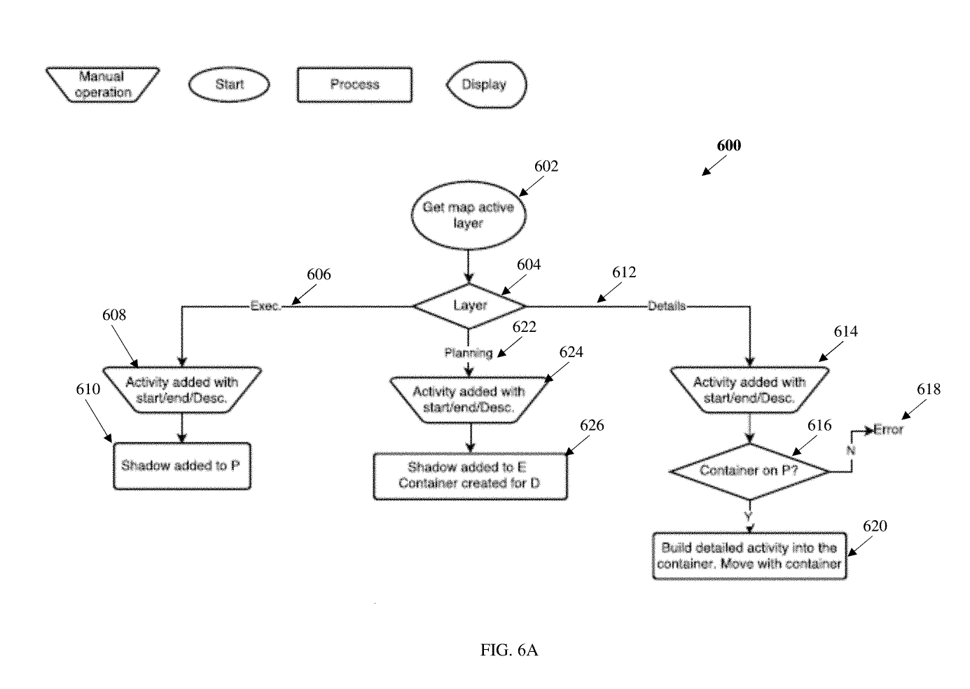

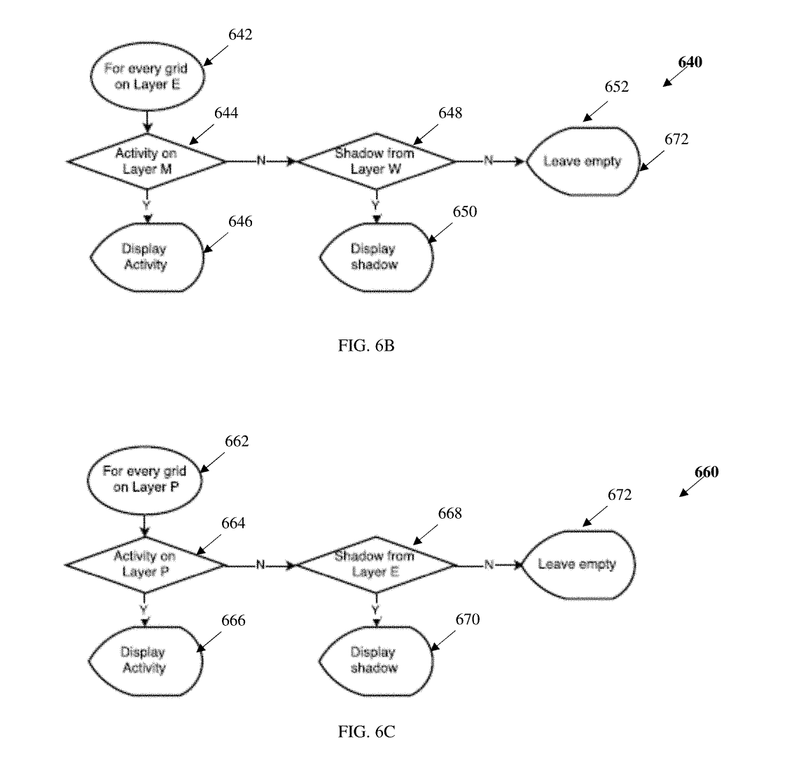

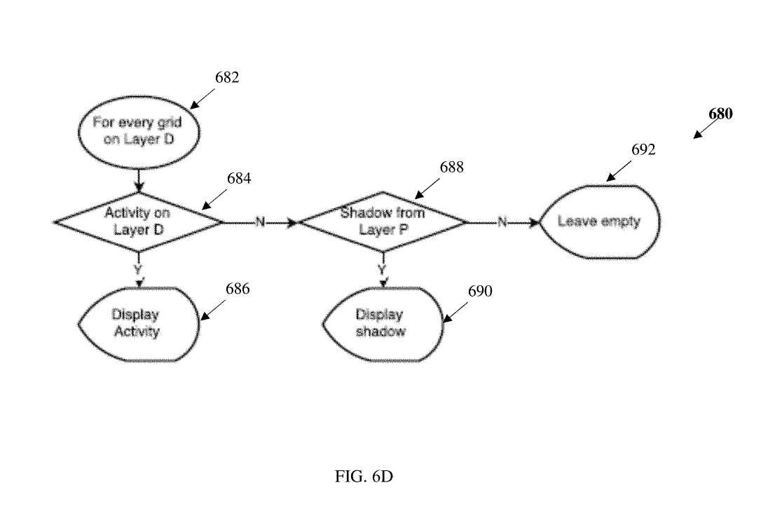

Reference is now made to FIGS. 6A-6D, which are schematic flowcharts illustrating methods 600, 640, 660 and 680, respectively, for generating a project plan, according to some embodiments of the present invention. FIG. 6A schematically illustrates a method 600 of adding an activity to any of the layers of the project management plan, e.g., to any of the levels of detail, thereby affecting the other levels of details of the project management plan. As indicated in block 602 a project management plan with an active layer may be acquired, e.g., displayed by the GUI. The active layer may be one of the levels of detail that may be displayed on the main graphical user interface of the system. As indicated in block 604, the processor may determine the type of layer that is displayed via the GUI. For example, the processor may determine whether the active layer is the layer of greatest granularity. i.e., the level named ‘Details’, whether it is the layer of medium granularity named ‘Planning’, or whether the active layer is the layer of lowest granularity and lowest level of detail, i.e., ‘Executive’ or ‘High Level’.

In case the active layer is the layer with the least level of detail, e.g., layer 606 (Executive or High level), as indicated in block 608, the processor may receive a command via the GUI to add an activity. The added activity may include various characteristics such as start time, end time, the activity's description, etc. As indicated in block 610 a shadow activity may be added to layer P, whereby P denotes Planning, which is the layer of medium level of detail. A shadow activity may be an empty box that awaits further user input with respect to the details of the activity to be added to a certain layer where the shadow activity is added. In this case, an activity was added to layer E (denoting Executive), and a shadow is added to the layer that is one layer above with respect to level of detail, i.e., layer P. Presence of a shadow may indicate a user that an activity was defined at a different layer than the layer in which the shadow is added.

In case the active layer is determined as the one with greatest granularity, i.e., greatest level of detail 612, named Details, as indicated in block 614, the processor may receive a command via the GUI to add an activity to that Details Level, also referred to as layer D. The added activity may include various characteristics such as start time, end time, the activity's description, etc. As indicated in block 616, it may be determined whether a container was created on layer P, e.g., whether the processor received a command via the GUI to create a container. A container may describe the relationship between layers, e.g., between the Planning layer and the Details layer. A container may be an empty space to which details with respect to a new activity may be inserted, whereby the new activity corresponds to an activity present in the most detailed level of the project management plan. An activity may be created in the most detailed level (e.g., layer D) if a shadow or container activity is created in the medium level of details layer, e.g., layer P. If a container is created on layer P then a detailed activity may be built into that container, and the detailed activity be moved with the container to the location of the container along the timeline and AOAs of the project management plan, as indicated in block 620. If no container is created in block 616, the processor may generate an error message that may be displayed by the GUI of the system, as indicated in block 618.

In case the active layer is determined as the one with medium granularity, i.e., medium level of details 622, named Planning, as indicated in block 624, the processor may receive a command via the GUI to add an activity to the Planning level, also referred to as layer P. The added activity may include various characteristics such as start time, end time, the activity's description, etc. Following addition of an activity as indicated in block 624, a shadow may be added to layer E, while a container may be created for layer D, as indicated in block 626.

In some embodiments, a shadow and a container may assist to remind a user to add activities in less or more detailed levels or layers once corresponding activities were added in certain other more or less detailed layers or levels.

FIG. 6B schematically illustrates method 640, which specifies when an activity is displayed and when a shadow is displayed with respect to an additional type of layers, e.g., corresponding to Months, Weeks and Days. That is, in this embodiment, the most detailed level is the Days layer or layer D, while the least detailed level is the Months or M layer. And the medium level of details, is the Weeks or W layer. Any other names for the different layers or different levels of details may be implemented.

According to some embodiments, for every grid on layer E (denoting Executive), as indicated in block 642, it may be determined whether or not an activity is added on layer M (while M denotes Months, as mentioned hereinabove), as indicated in block 644. That is, for every grip on Layer E, which is the layer with least details, or layer of highest level, it should be determined whether or not an activity is added on that layer of highest level, also referred to as layer M, as indicated in block 644. If an activity is added on layer M, then the activity may be displayed via the GUI, as indicated in block 646. If no activity is added on layer M, then the processor may determine whether or not a shadow is added with respect to layer W (denoting the medium layer Weeks), as indicated in block 648. If a shadow is added on layer M corresponding to an added activity in layer W, the shadow may be displayed via the GUI, as indicated in block 650. However, if a shadow was not added on layer M with respect to an activity added on layer W, the GUI of the project management plan displaying layer M is left empty, such that no activity nor shadow is displayed, as indicated in block 672.

FIG. 6C schematically illustrates method 660, which specifies when an activity is displayed and when a shadow is displayed with respect to medium layer P. For every grid on layer P, as indicated in block 662, it may be determined whether or not an activity is added on layer P (following the processor receiving a command via the GUI to add an activity to layer P), as indicated in block 664. If an activity is added on layer P the activity may be displayed via the GUI, as indicated in block 666. However, if an activity is not added to layer P, then the processor may determine whether or not a shadow is added with respect to layer E, as indicated in block 668. If a shadow is added on layer P corresponding to an added activity on layer E, the shadow may be displayed via the GUI, as indicted in block 670. If a shadow was not added on layer P with respect to an added activity on layer E, the GUI of project management plan displaying layer P is left empty with no added activity and no added shadow activity, as indicated in block 672.

FIG. 6D schematically illustrates method 680, which specifies when an activity is displayed and when a shadow is displayed with respect to layer D, which is the layer of greatest level of detail. For every grid on layer D, as indicated in block 682, the processor may determine whether or not an activity is added on layer D, as indicated in block 684. If an activity is added on layer D, the activity may be displayed via the GUI, as indicated in block 686. If an activity is not added on layer D, is the processor may determine whether or not a shadow is added, with respect to an activity added on medium layer P, as indicated in block 688. If a shadow was added with respect to an added activity of layer P, then the shadow activity is displayed via the GUI, as indicated in block 690. If a shadow was not added, the GUI of the project management plan displaying layer D is left empty and no activity nor shadow are added to layer D, as indicated in block 692.

Reference is now made to FIG. 7A, which schematically illustrates a user interface displaying a graphic representation of a project management plan of a first granularity, according to embodiments of the present invention. FIG. 7A schematically illustrates the user interface displaying a graphic representation of the project management plan map using a view that details several AOAs 701, according to some embodiments of the present invention. For example, AOAs 701 may comprise “Hardware” 720, “Test” 722, sub AOAs “user testing” 724 and “performance testing” 726, and further AOAs such as “Qualification” 728, “Accessories” 730, and “Documentation” 732, or the like. FIG. 7A may illustrate the project management plan in “daily” time scale level, along timeline 704. Similar project management plans may be presented in other time scale levels, such as by week, month, quarter, year, etc. Other project management plan presentation maps may comprise several level of details within the same display per the time scale, for example, illustrating weekly activities within their parent monthly activity or any other combination.

In some embodiments, the user interface of the first granularity level may comprise box 706 named ‘Today’, which when selected by a user may illustrate a line or some other graphic illustration indicating the current day along the project management plan display, such that a user may have reference as to the status of activities per a specific day along timeline 704.

According to some embodiments, FIG. 7A may illustrate the user interface of the first granularity, e.g., the layer named Details. The user may select the specific granularity from a list of levels of details 708. Once a specific level is selected, the activities and AOAs corresponding to that level may be displayed to the user via the GUI.

In some embodiments, the GUI of FIG. 7A may illustrate several activities, e.g., activity 710, which corresponds to area of activity 720. In some embodiments, activity 712 may correspond to sub-AOA 726, which is a sub-area of activity of AOA 722. In some embodiments, the status of progress of any activity, e.g., activity 712, may be displayed by marking activity 712 with different colors. The percentage of completeness of activity 712 may be illustrated in one color, while the percentage of activity 712 that is not yet complete, may be illustrated at a different color. In some embodiments, AOA 728 may comprise several related activities, e.g., activity 714 and activity 718. In some embodiments, a buffer, e.g., buffer 716 may be inserted between activities. A buffer may indicate a certain time period that is to pass from the end of one activity and prior to the beginning of another activity, or it may indicate a period of time added between activities such to provide an additional time period for completing a predecessor activity prior to beginning a successor activity. Any number of buffers may be added per each AOA between two activities, and any number of activities may be displayed per any AOA.

Reference is now made to FIGS. 7B-7C, which schematically illustrate a user interface displaying a graphic representation of a project management plan of a second granularity, according to embodiments of the present invention. The second granularity may be the ‘Planning’ level of details, which may be selected by a user in area 708. The project map may further comprise area of activity 701, which may comprise a list of AOAs, e.g., AOA ‘Hardware’ 740, “Software” 742, sub-AOA ‘sprints’ 744 and sub-AOA ‘SW documentation’ 746, which are sub-areas of activity of AOA 742. AOA 701 may further comprise AOA “HW Qualification” 748, “SW Qualification” 750, Packaging” 752, “Mechanics” 754, “Test” 756 that comprises two sub-AOAs: ‘quality’ 758 and ‘reliability’ 760, “Certification” 762, “Accessories” 764, and “Documentation” 766, or any other. A plurality of activities may be displayed by the project map illustrated by FIGS. 7B-7C. Among which, an example of an activity may be activity 770, which corresponds to AOA 748. In addition, activity 772 and activity 774 may both correspond to AOA 740. As highlighted by FIG. 7C, activity 770 may be linked to activity 772 via link 776, which connects the end of activity 772 to the beginning of activity 770. Furthermore, activity 770 may be linked to activity 774 via link 778, such that the end of activity 770 is connected to the beginning of activity 774. Additional links between other activities may be implanted and displayed by the project management map, per any level of details. Typically, the links define the project's structure.

In some embodiments, milestone 780 may be displayed via the GUI of the project map. A milestone may be a deadline for completion of all or substantially all, or the majority of activities of substantially all AOAs. That is, a milestone, e.g., milestone 780 may be the deadline by which completion of all or substantially all or the majority of activities is to be accomplished.

Reference is now made to FIG. 7D, which schematically illustrates a user interface displaying a graphic representation of a project management plan of a third granularity, according to embodiments of the present invention. The third granularity may be ‘High Level’, which may be selected by the user in area 708. The project map may further comprise area of activity 701, which may comprise a list of AOAs, e.g., AOA ‘Hardware’ 740, “Software” 742, sub-AOA ‘sprints’ 744 and sub-AOA ‘SW documentation’ 746, which are sub-areas of activity of AOA 742. AOA 701 may further comprise AOA “HW Qualification” 748, “SW Qualification” 750, Packaging” 752, “Mechanics” 754, “Test” 756 that comprises two sub-AOAs: ‘quality’ 758 and ‘reliability’ 760, “Certification” 762, “Accessories” 764, and “Documentation” 766, or any other.

According to some embodiments, the third granularity may include a higher level of details of activities that correspond to certain AOAs, compared to the level of details of the activities displayed on the second granularity (FIGS. 7B-7C). For example, as illustrated in FIG. 7D, that activity 782 of third granularity, named ‘HW build 1’, under “Hardware” AOA, includes a plurality of detailed activities, as displayed on FIG. 7C, e.g., ‘PCB (Printed Circuit Board)’ 777, SMT (Surface Mount Technology)′ 775, ‘Test’ 773 and ‘Ship’ 772. Similarly, any activity of the third granularity includes several activities of the second granularity, which provide additional details on what activities constitute the ‘High-Level’ activity of the third granularity. That is, the second granularity provides the detailed activities that the third granularity consists of.

In some embodiments, milestone 780 may be displayed via the GUI of the project map.

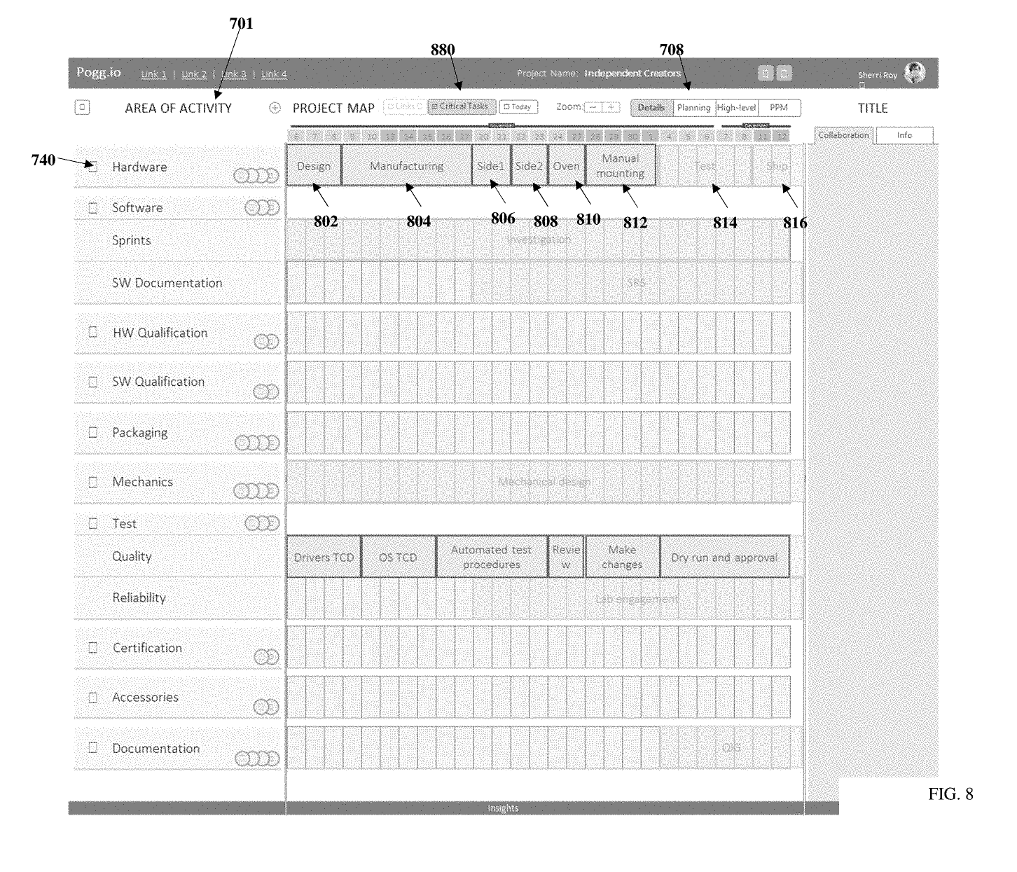

Reference is now made to FIG. 8, which schematically illustrates a user interface displaying a graphic representation of critical tasks in a project management plan of a first granularity, according to embodiments of the present invention. In some embodiments, a critical task is a task that is required to be fully accomplished before proceeding onto a different activity. Critical tasks are usually those tasks that should be carefully monitored by a user, since if they are delayed, they usually cause further delays in other related activities along the project map or project plan.

According to some embodiments, each activity may comprise a list of critical tasks 880, which are required to be accomplished in order to finalize the activity, and mark the activity as done. A user may select box 880 in order to display all critical tasks per a certain level of detail. In this example, the level of detail is of a first granularity, e.g., the greatest level of detail. For example, based on the list of detailed activities displayed on FIG. 7C under the “Hardware” AOA, specifically activities ‘PCB’ 777 and ‘SMT’ 775, the critical tasks for these activities, may be as illustrated and displayed on FIG. 8: activity 802 ‘Design’, activity 804 ‘Manufacturing’, activity 806 ‘Side1, activity 808 Side2’, activity 810 ‘Oven’, and activity 812 ‘Manual Mounting’, or any other.

According to some embodiments, in any of the granularity displays or GUIs, some activities may be displayed in bold or highlighted manner, and some activities may be displayed in a lighter and less apparent manner, though still visible. The bold and/or highlighted activities, are the main activities relevant to the specific level of details that is currently displayed, while the less apparent activities are activities that may be relevant to a different level of detail. These activities of other levels of details are also displayed on a GUI that seems less relevant to them, since they provide context. For example, activity 814 ‘Test’ and activity 816 ‘Ship’ are displayed in a lighter script compared to that of activities 802, 804, etc. However, they provide context to the other bold activities, since the user may determine which additional activities follow the highlighted activities, under the same AOA, or under other AOAs.

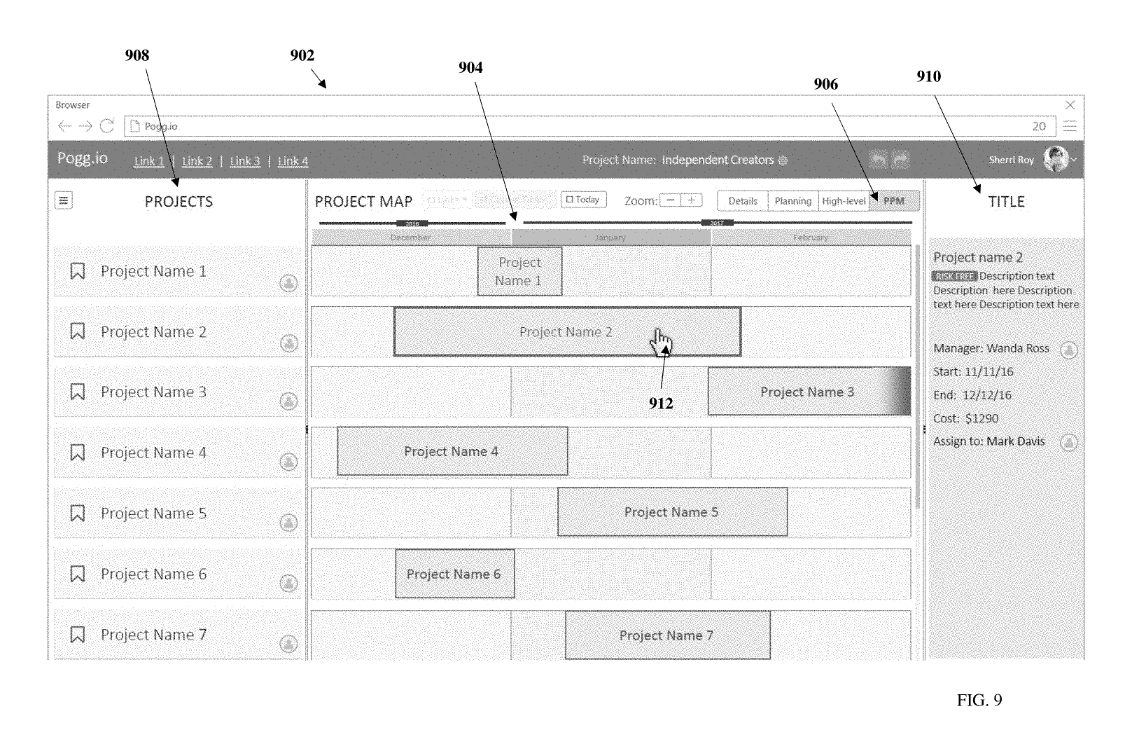

Reference is now made to FIG. 9, which schematically illustrates a user interface displaying a graphic representation of indicators per project of a project portfolio management, according to embodiments of the present invention. According to some embodiments, FIG. 9 illustrates a display of a plurality of projects along a timeline 904. A user may select box 906 and thus open the display of the plurality of projects 908 per user. For example, the project portfolio management 902 may comprise project 1 to project 7, each located along timeline 904 according to a predetermined duration and beginning time per each project.

In some embodiments, in any of the displays of the project map or project plan, there may be an area which may include additional details on, for example, the manager in charge of the project(s), start and end time per each project, which may be displayed substantially permanently on the screen, or it may appear per project or activity that the user selects, e.g., by placing or clicking a cursor 912, touching a touch screen, etc. Further details that may be displayed to a user may be the person assigned to handle each activity or project. For example, FIG. 9 illustrates box 910 that displays additional details with respect to project 2 (which is the project that the cursor 912 is placed on), such as the description of the project, the name of the manager of project 2, start and end date of project 2, the costs of project 2, and the person assigned to accomplish project 2. Similar details and/or other details per any other project may be displayed in box 910.

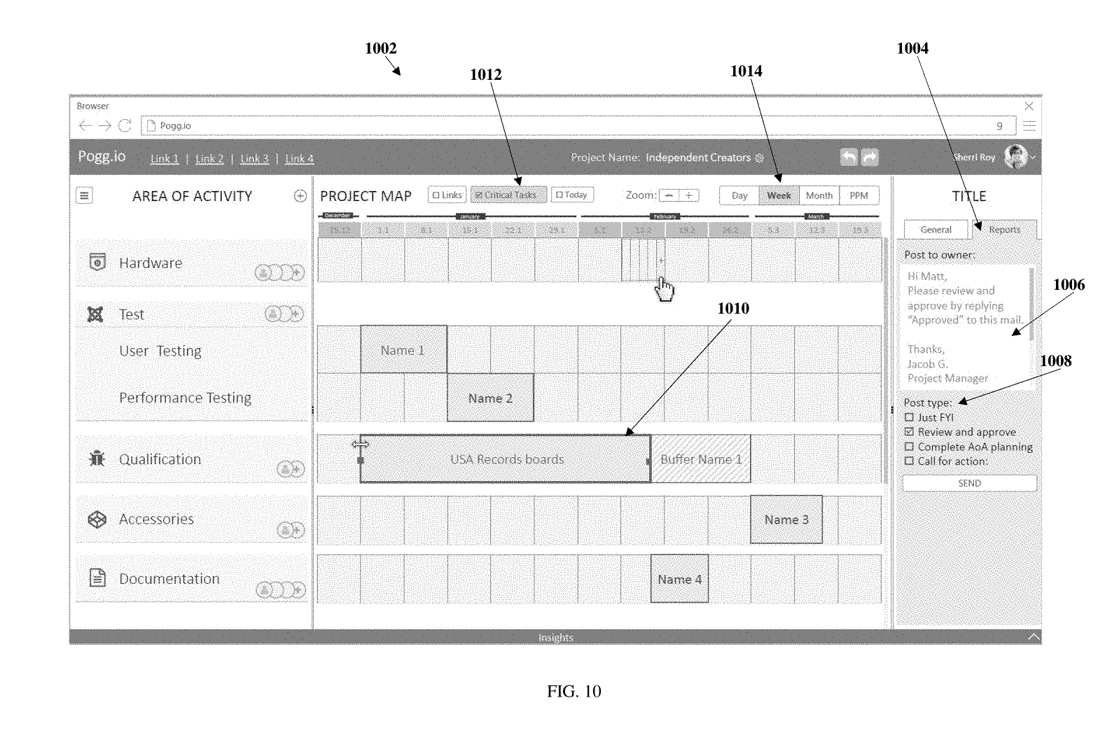

Reference is now made to FIG. 10, which schematically illustrates a user interface displaying a graphic representation of a project management plan including a message to owner of the project plan, according to embodiments of the present invention. According to project map 1002, the GUI may display critical tasks 1012 among the activities per AOAs. The time scale 1014 may be of weeks, though any other time scale may be displayed, e.g., days, months, quarters, years, etc. project map 1002 may display reports 1004 per any selected activity, e.g., activity 1010, named ‘USA Records Boards’.

In some embodiments, reports 1004 may comprise box 1006, which may enable a user to insert a message, post or report to the manager of the project or the activity or to the person assigned to accomplish the activity. For example, the contents of message 1006 may be to remind the person assigned to finish the activity to review the activity and determine whether it has ended, whether it is still in progress, or whether it has not begun yet. The contents of message 1006 may be to ask the manager of the activity or project to approve status of progression of the activity, and so on.

In some embodiments, reports 1004 may further comprise section 1008, which may provide a user the ability to select the type of report, e.g., whether the report is merely a reminder, whether it requires review and/or approval, whether AOA planning should be completed, or whether the report calls for action. In other embodiments, additional types of reports may be implemented.

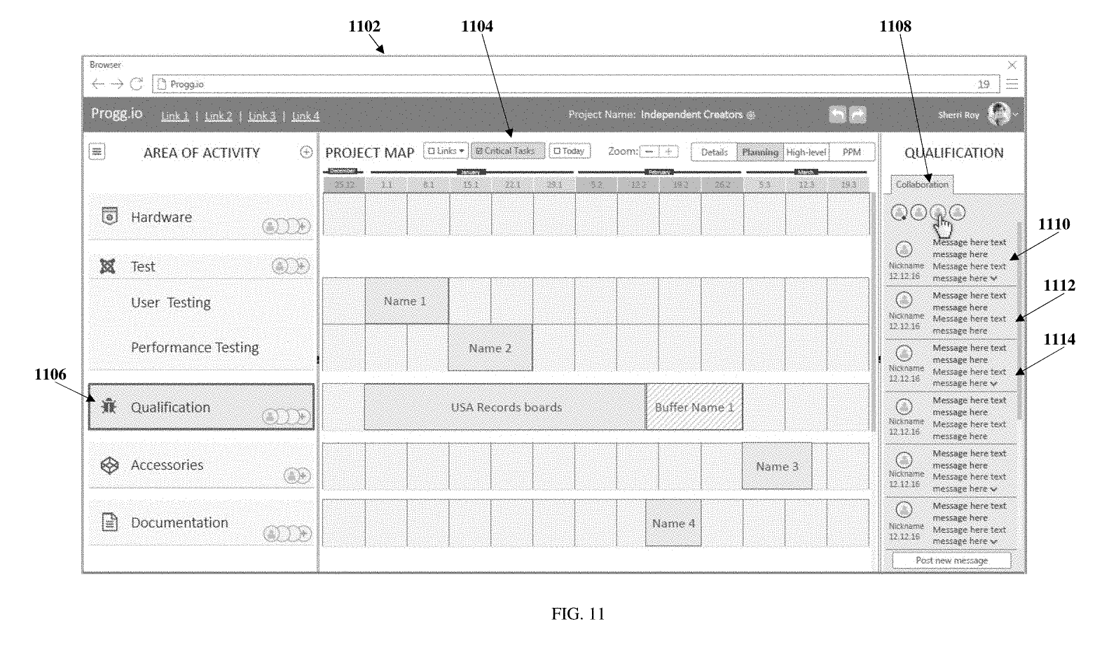

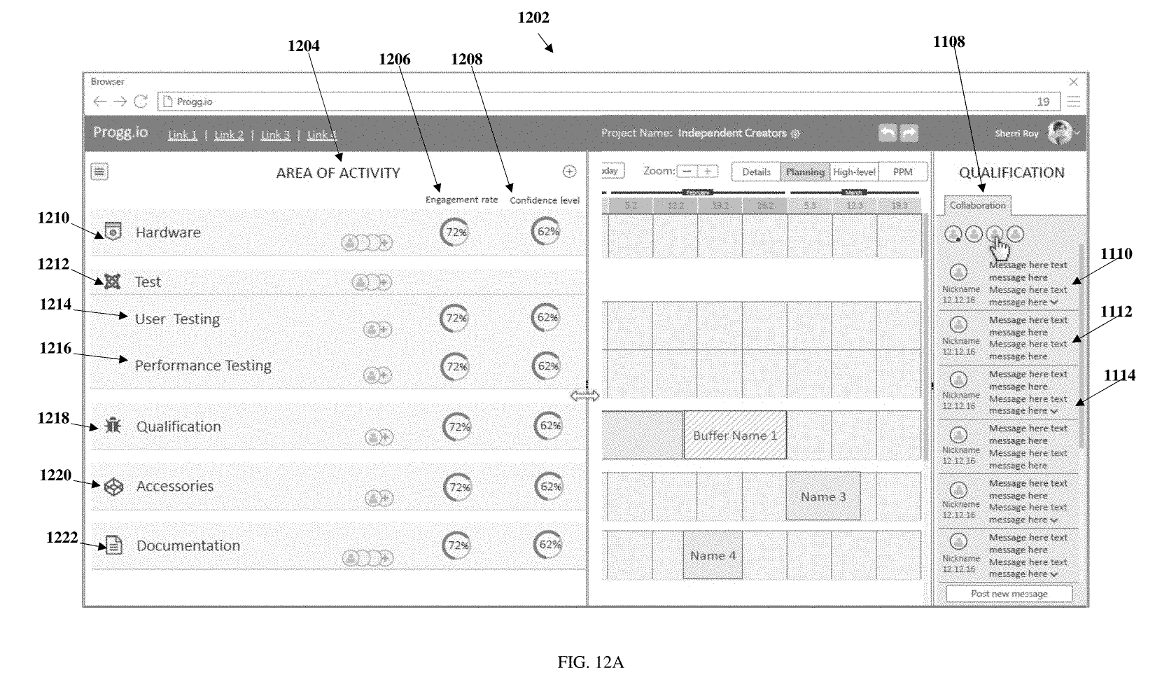

Reference is now made to FIG. 11, which schematically illustrates a user interface displaying a graphic representation of a project management plan including messages to members of the team that are to accomplish the project, in order to establish collaboration between the team members, according to embodiments of the present invention. According to project map 1102, the user interface may display the critical tasks 1104. The critical tasks may be displayed per AOA. The GUI illustrated in FIG. 11 may be configured to enable users relevant to a specific AOA, e.g., team members, to collaborate information among themselves, for example, with respect to the AOA or with respect to a specific activity or project.

For example, project map 1102 may comprise a collaboration section 1108, which may display correspondence between users, e.g., employees that are assigned to handle a specific AOA, or a specific project or activity. Collaboration 1108 may comprise messages between users, e.g., messages 1110, 1112, and 1114.

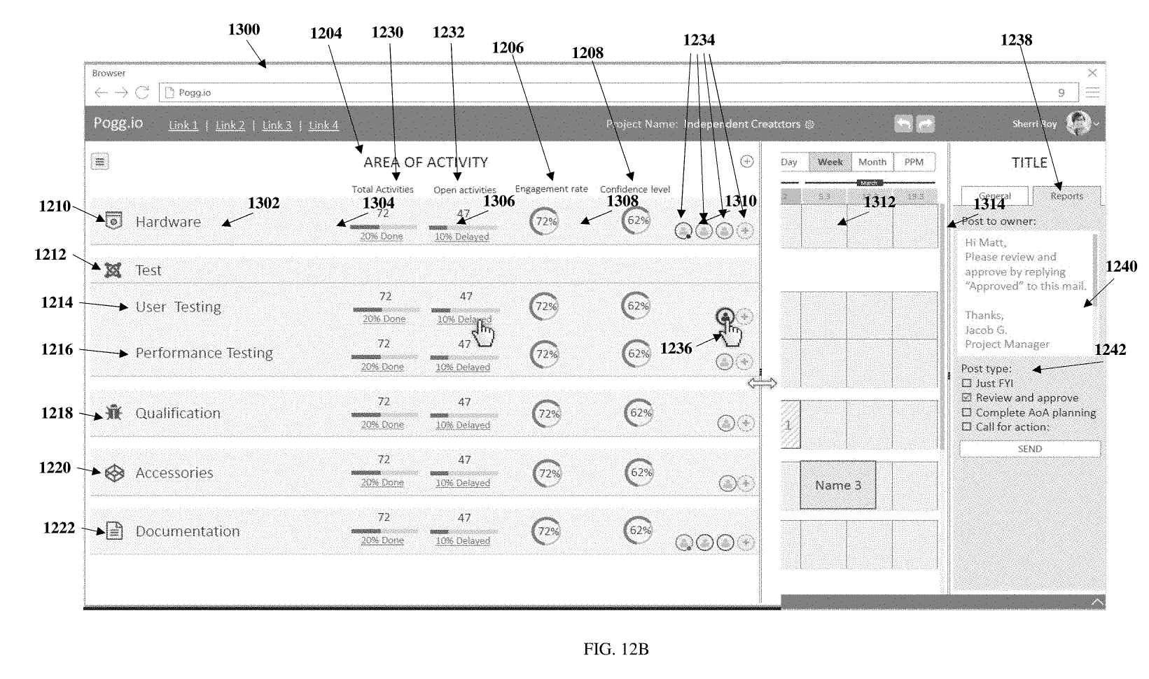

Reference is now made to FIGS. 12A-12B, which illustrate a user interface displaying a graphic representation of a project management plan including engagement rate per area of activity and confidence level per area of activity, and total activities and open activities, respectively, according to embodiments of the present invention. In some embodiments, project map 1202 may display in addition to collaboration section 1108, which comprises messages between users or team members, e.g., messages 1110, 1112, 1114, etc., Engagement rate 1206 and Confidence level 1208. The engagement rate may determine the level of engagement per area of activity or per activity by the team members. Engagement rate may be calculated based on analysis of the traffic of ongoing and incoming messages with respect to a project. Calculation of engagement rate may be based on the type of messages between team members, the type of response per message, and a user's action along the project management map due to a message. Calculations of engagement rate may count the response time and the time from the last engagement per a specific activity. An engagement rate may be aggregated and calculated per area of activity, and may also be calculated per an entire project. For example, if one team member posts messages another team member, e.g., via reports 1004 (FIG. 10) or via collaboration section 1108, and the other team member that receives the message responds, in such case the engagement rate 1206 may be higher compared to the engagement rate in case the other team member did not respond at all. In addition, if the other team member not only responded but rather reviewed an activity, or made some change to the project map, then the engagement rate would be even higher. The engagement rate is a tool that assists a company to determine how committed the company and its employees are with respect to a certain activity or with respect to a certain area of activity or project.

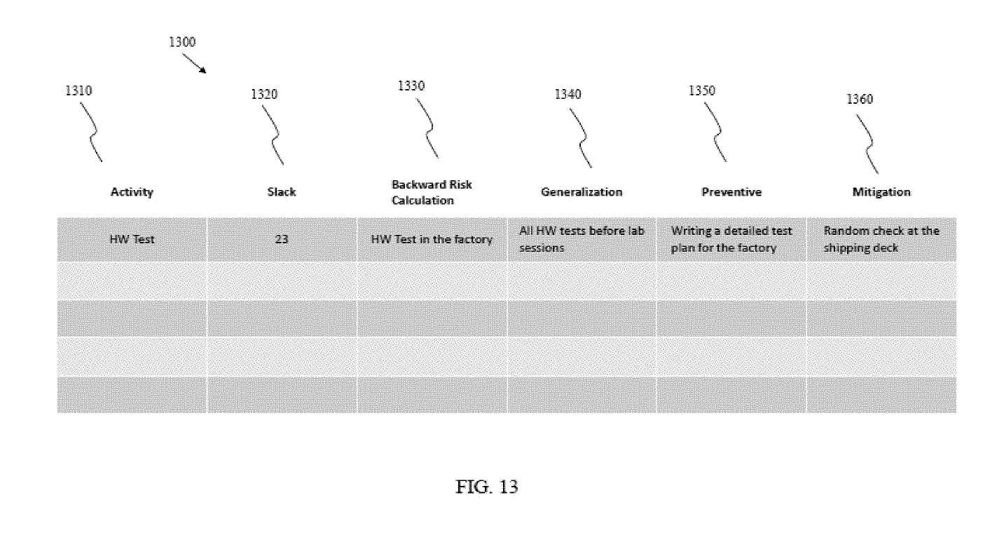

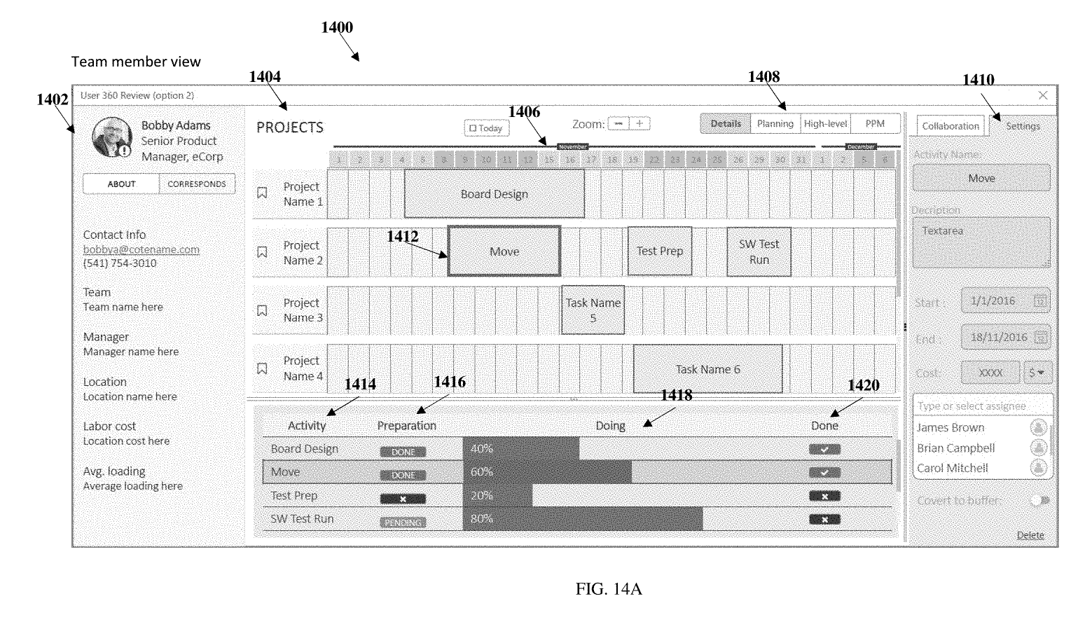

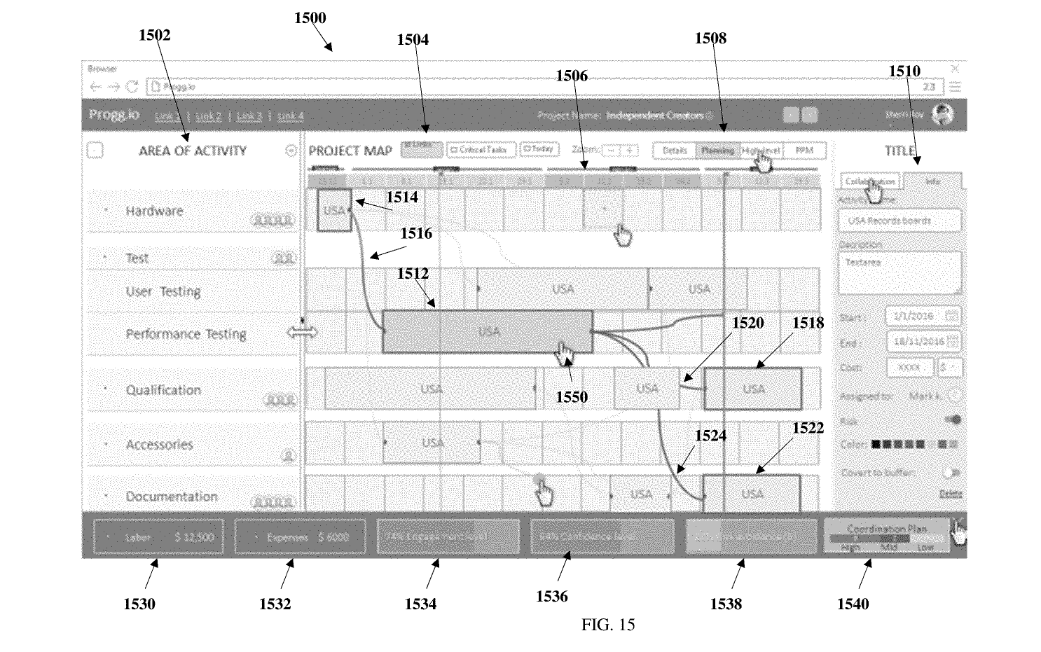

In some embodiments, Confidence level 1208 may be determined according to the number of links connected to a specific activity. Confidence level may be calculated per activity and may be aggregated per area of activity and per an entire project. Calculations of a confidence level may take into consideration three main factors: (1) the map structure, e.g., an activity with many predecessor activities has a lower confidence level, as it has less chances of happening; (2) the nature of the predecessor activities, e.g., their risk, their own confidence level, etc.; and (3) the way risk and links are handled in the risk plan (e.g., risk plan 1300, FIG. 13) and coordination plan (e.g., coordination plan 1540, FIG. 15).

According to some embodiments, the confidence indicator or confidence level may be reduced according to the map structure, e.g., when more links are created between areas of activity. However, the confidence level may be increased due to high level of team activity around risks and coordination. Thus, the team members have a way to improve the confidence level, which may push the team members to be more involved and proactive with respect to activities and risks present along the project management plan.

In some embodiments, the confidence level may be calculated based on big data learning (for example, by collecting and processing a significant amount of data related to many projects' structures) as captured by a central database, e.g., database 150. According to some embodiments, after the presented methods for dynamically updating and displaying project management plans via a GUI would be in use for a certain time period, information regarding many projects and the way they behaved over time would be stored in a central database, e.g., database 150. The behavior of the projects' maps or projects' structure may include, for example, the number of changes made along the project, the scores per coordination, risk, confidence and engagement, and the final results, e.g., delivery by the deadline. All of this information and/or other similar information related to the projects' structure's behavior may be stored by a big-data engine.

In some embodiments, the confidence level may be calculated using a dynamic algorithm, which may be configured to learn from its own previous calculations.

For example, an activity I from AOA A that is linked to an activity II from AOA B, is less likely to happen, since activity I is dependent on another activity, e.g., activity II. Thus, if for example, activity I without any links could be 100% accomplished, once connected to an activity from a different AOA, the confidence level is decreased to 80%, for example. If an activity I is linked to activities of two different AOAs, the confidence level is decreased to 60%. And if activity I is linked to more than two different AOAs, it is not likely to ever be accomplished, since it depends on too many variants. In order to raise the confidence level 1208, a manager may either remove one or more links, or the manager may resolve one of the links. The aggregation of all activities under a certain AOA, may be used to determine the likelihood of success of a project.

For example, per AOA 1210 ‘Hardware’, the Engagement rate 1206 may be 72%, and the Confidence level may be 62%, while per a different AOA, these two parameters may also be different.

FIG. 12B provides additional information with respect to the number of total activities 1230 related to a specific AOA, as well as with respect to the number of open activities 1232 related to that specific AOA. For example, with respect to AOA 1210 ‘Hardware’, the total activities related to ‘Hardware’ are 72, and the open activities related to ‘Hardware’ is 47. In some embodiments, the GUI may further display the percentage of complete activities with respect to the total number of activities, under the specific AOA, as well as the percentage of delayed activities, with respect to the open activities under that specific AOA. For example, for the total number of activities 1230 per ‘Hardware’ AOA, the percentage of complete activities is 20%. And for the number of open activities 1232 under ‘Hardware’, the percentage of delayed activities is 10%. Similarly, the number of total activities 1230 and the percentage of complete activities, as well as the number of open activities 1232 and the percentage of delayed activities may be displayed per any AOA.

According to some embodiments, GUI 1202 may further comprise the display of icons 1234 representing team members that are relevant to accomplishing activities that correspond to a certain AOA. Icons 1234 may be selected by a user, e.g., via cursor 1236, such that a message may be sent to the selected team member. The message or post 1240 may be added via reports section 1238. In some embodiments, the team member composing the message or post may select the type of report, as detailed with respect to FIG. 10. In some embodiments, a user may add additional team members or may remove team members that are not relevant to the AOA.

Reference is now made to FIG. 13, which schematically illustrates a risk plan, according to embodiments of the present invention. Risk plan 1300 may provide and display information regarding the activities of the project management plan that are considered to include a risk. Risk plan 1300 may further display information with respect to the preventive and mitigation actions that may be performed in order to reduce the risk of these activities.

According to some embodiments, risk plan 1300 may comprise a list of activities 1310, which are considered to comprise a certain risk during their accomplishment or if not accomplished. Risk plan 1300 may further comprise details per the type of risk that activities 1310. “Slack” 1320 may represent the distance from a risky activity and a critical chain. The critical chain is the shortest route to the end of the project and is calculated based on activities duration and dependencies between activities. The slack is the distance (in days) between the activity marked with risk to the critical chain. It represents the number of days the activity can be delayed before pushing project completion to a future date. Slack=0 means activity on the critical chain.

A “Backward risk calculation” 1330 may be displayed per each risky activity. “Backward risk calculation” 1330 may represent the step preceding the risky activity whereby preventing the preceding step may assist in overcoming the defined risk 1310. For example, if “HW failure after shipment” is defined as a risk, “HW test in the factory” may be defined as backward risk calculation and may be referred to it in the preventive plan 1350 and mitigation plan 1360. By preventing any issue with “HW test in the factory”, the risk “HW failure after shipment” is unlikely to be addressed, since its preceding activity “HW test in the factory”, which may have direct impact on the risk “HW failure after shipment” was already addressed and resolved.

Risk plan 1300 may comprise a Generalization section 1340, which may refer to additional activities in the same project suffering from the same risk. For example, if “HW failure after shipment” is defined as risk for the first Hardware cycle, risk generalization may indicate all Hardware shipments from the factory in that analysis, such that second and third (and so on) Hardware cycles may be included.

In some embodiments, risk plan 1300 may comprise Preventive plan 1350, which may refer to preventive actions that may be done in order to avoid the risk. Each risky activity 1310 may have a respective preventive plan 1350. Risk plan 1300 may further comprise a mitigation plan 1360, which may comprise actions that may be done in case of risk materialization, in order to reduce the risk's impact on the project plan. That is, mitigation plan is executed once the risk already appeared, and thus mitigation includes the actions that should be done in order to reduce the effect of the risk on the entire project management plan. Each risky activity 1310 may have a corresponding mitigation plan 1360. For example, in case the risk is “HW test in the factory”, a preventive action may be writing a detailed test plan for the factory, and a Mitigation plan might be a random check at the shipping deck to find test escapees.

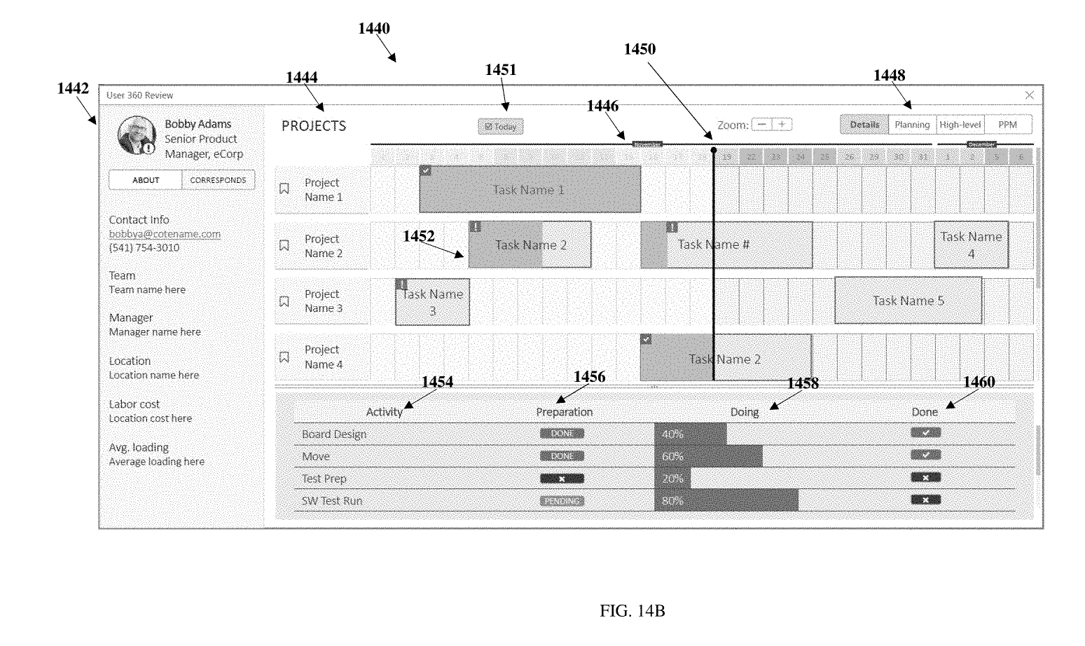

Reference is now made to FIGS. 14A-14B, which schematically illustrate a user interface displaying a graphic representation of team member view of the member's pending projects, according to embodiments of the present invention. According to FIG. 14A, GUI 1400 may display a list of projects as well as their progress level, per team member. For example, GUI 1400 may comprise a display of details on the specific team member 1402. The details on the team member may include the name of the team member, the member's position, contact information (e.g., email address, telephone number, etc.), name of team the member is part of, name of the manager of the team, location per company's sites, labor cost (value of the member hourly work, or any other calculations per costs of work done by the team member), loading (the amount of activities assigned to the specific employee/team member), and any other additional or other, information.

In some embodiments, a list of projects 1404 may be displayed via GUI 1400. The projects' list includes all or substantially all projects in which the specific team member's involvement is required. GUI 1400 may comprise a timeline 1406, such that the projects are displayed in context of a time scale. The GUI 1400 may enable selection of one of the optional levels of details of the project management plan, e.g., one of the granularity levels displayed under box 1408. The activities that are under the responsibility of the specific team member 1402, are displayed along the timeline 1406, per project.

In some embodiments, once a certain activity, e.g., activity 1412 may be selected, e.g., via a cursor placed onto the activity's displayed icon, or by clicking the icon, etc., a optional setting manual 1410 may open, such to allow adding details, definitions and to enable changes to the features and characteristics of the marked or selected activity, e.g., activity 1412.

In some embodiments, GUI 1400 may further display details regarding progress of accomplishment of each activity indicated on GUI 1400. For example, GUI 1400 may display a list of activities 1414, and status of preparation 1416, which may indicated whether preparations required prior to beginning the activity were handles, e.g., whether preparations are done, pending or have not begun yet. GUI 1400 may further display the percentage of progress in completing/doing the activity 1418, and the possibility to display which of the activities is done, as indicated by column 1420.

According to FIG. 14B, GUI 1440 may display a list of projects as well as their progress level, per team member, according to another embodiment. Similarly to GUI 1400, GUI 1440 may comprise a display of details on the specific team member 1442, as mentioned above in detail. Additionally, GUI 1440 may comprise a display of a list of projects 1444, and activities per project along timeline 1446, e.g., activity 1452. Similarly to GUI 1400, GUI 1440 may enable selection of one of the optional levels of details of the project management plan, e.g., one of the granularity levels displayed under box 1408. Similarly to GUI 1400, GUI 1440 may further display details regarding progress of accomplishment of each activity indicated on GUI 1440. For example, GUI 1440 may display a list of activities 1454, and status of preparation 1456, which may indicated whether preparations required prior to beginning the activity were handles, e.g., whether preparations are done, pending or have not begun yet. GUI 1440 may further display the percentage of progress in completing/doing the activity 1458, and the possibility to display which of the activities is done, as indicated by column 1460.

In some embodiments, GUI 1440 may enable selection of the current day, i.e., to select ‘Today’ under box 1451, thus displaying line 1450 along the plan, in order to easily illustrate the progress of the activities up to a certain point in time being the current day that the team member 1442 enters GUI 1440. The progress status may also be displayed via each specific icon of activity, such that the percentage of the activity that was already accomplished may be marked at a color/hue/filling different from that of the percentage of the activity that is yet to be accomplished.

Reference is now made to FIG. 15, which schematically illustrates a user interface displaying a graphic representation of a project management plan of a second granularity level including among others engagement and confidence levels, and risk avoidance level, according to embodiments of the present invention. According to some embodiments, GUI 1500 may display the second or medium level of detail selected from the optional levels of detail of the project management plan. GUI 1500 may display the AOAs 1502, and the activities per each AOA, as well as links 1504 that connect between activities, either from the same AOA or from different AOAs. Links box 1504 may be selected such to display the links between activities. For example, the beginning of activity 1512 from AOA ‘Performance Testing’ may be linked to the end of activity 1514 via link 1516, while the end of activity 1512 may be linked to the beginnings of activities 1518 and 1522, via links 1520 and 1524, respectively. In some embodiments, all links between activities may be displayed at once, and in the same manner, e.g., in the same color and hue. In other embodiments, all links may be displayed via GUI 1500, however, only links that correspond to an activity that is marked or selected, e.g., by cursor 1550, may be more apparent, e.g., highlighted as compared to links of all other activities that do not correspond to the selected activity.

In some embodiments, once an activity is selected, e.g., by a cursor 1550, GUI 1500 may enable applying definitions and changing characteristics of the selected activity, e.g., via area 1510.

In some embodiments, GUI 1500 may display additional information with respect to engagement level 1534 and confidence level 1536, as described in detail with respect to FIGS. 12A-12B. GUI 1500 may further display risk avoidance level 1538, and coordination plan 1540. According to the present invention, the coordination plan 1540 may indicate the critical dependent activities, which are the activities that are linked to one another while being from different AOAs. A coordination plan may have at least two priority levels. A first Priority level may include dependencies between AOAs where the perceived expected miss-coordination is most probable. A second priority level may include dependencies between sub-AOAs where miss-coordination is considered less probable. Additional priority levels may be implemented.

According to the present invention, activities that are marked with perceived risk are considered risky by the user, e.g., activities marked with perceived risk are considered as high risk activities. For example, a vendor with bad reputation, activities where the organization has little knowledge, activities which were delayed in past projects, etc. Perceived risk (as opposed to calculated risk in prior art applications) is defined by the user's experience and according to the knowledge of the project's team. Thus, risk avoidance level 1538 may be calculated based on activities marked with perceived risk.

In some embodiments, GUI 1500 may display details related to money, e.g., labor (worth) 1530, and expenses 1532.

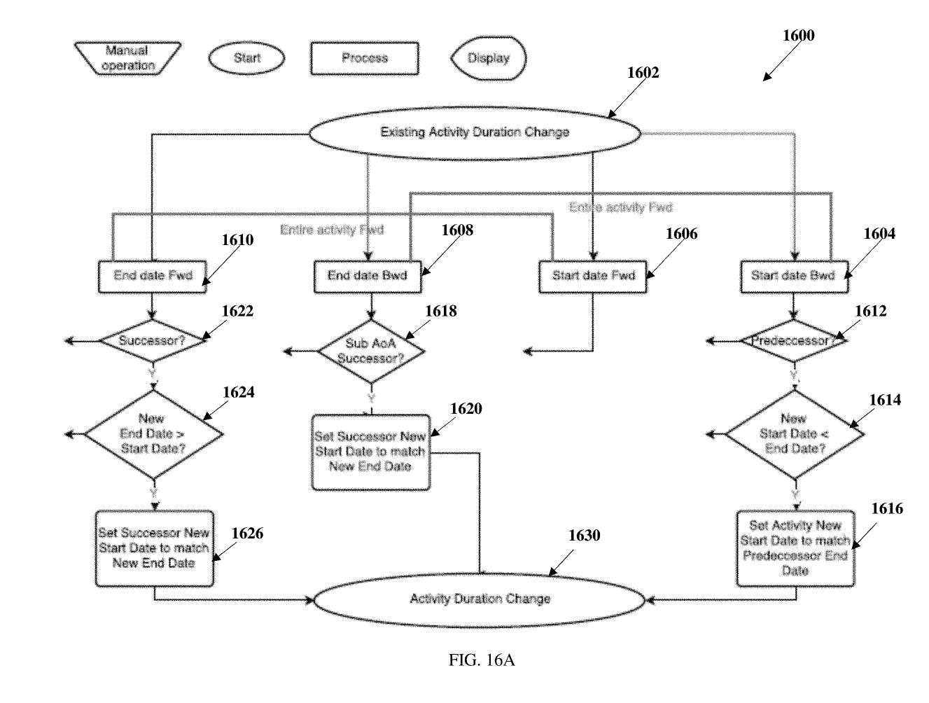

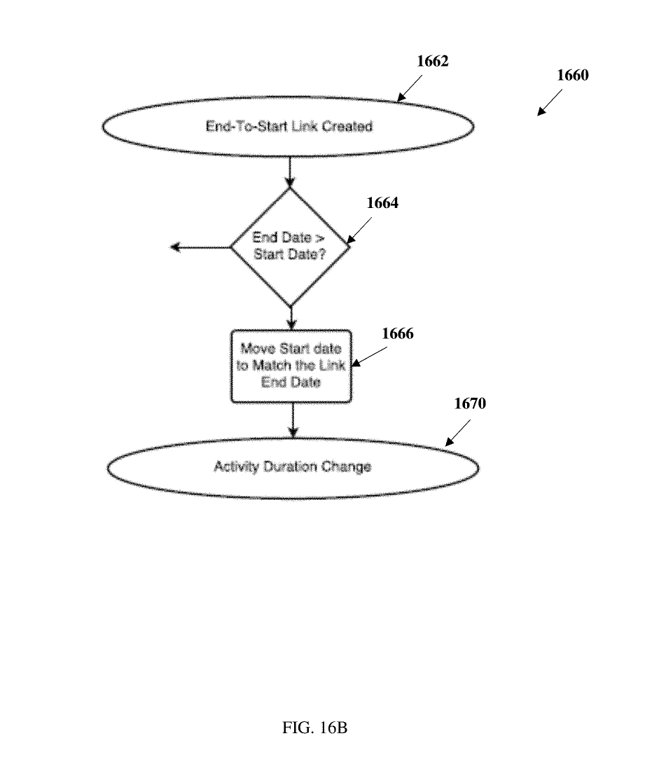

Reference is now made to FIGS. 16A-16B which are schematic flow charts describing methods 1600 and 1660, respectively, for changing existing activity duration, according to embodiments of the present invention. With respect to FIG. 16A, method 1600 may include a processor, e.g., processor 112 (FIG. 1A) configured to receive a command, via the GUI, to change duration of an existing activity, as indicated in block 1602. As indicated in block 1604, a processor may receive a command via the GUI to change the start date of an activity to an earlier date, e.g., change the start date of the activity backwards. As indicated in block 1612, the processor may indicate whether a predecessor activity exists per the current activity. If a predecessor exists, the processor is to determine whether the new start date of the current activity is earlier than the end date of the predecessor, as indicated in block 1614. If the new start date of the current activity is earlier than the end date of the predecessor, the processor may receive a command via the GUI to set the new start date of the activity to match the predecessor's end date, as indicated in block 1616. Thus, the current activity's duration is changed, as indicated in block 1630.

In some embodiments, it is possible that a processor receive a command via the GUI to change the start date of an activity to a later date, e.g., change the start date of the activity forwards, as indicated in block 1606.

In some embodiments, the processor may receive a command via the GUI to change the end date of an activity to an earlier date, e.g., change the end date of the activity backwards, as indicated in block 1608. The processor may then determine whether a sub-AOA successor exists, as indicated in block 1618. If such a successor exists, the processor may receive a command via the GUI to change the start date of the successor to a new start date that would match the new end date of the current activity, as indicated in block 1620. Thus, the activity duration is changed, as indicated in block 1630.

In some embodiments, the processor may receive a command via the GUI to change the end date of an activity to a later date, e.g., to set the end date of the activity forwards, as indicated in block 1610. The processor may then determine whether a successor activity exists, as indicated in block 1622. If a successor exists, the processor is to determine whether the new end date of the current activity is later in time as compared to the start date of the successor activity, as indicated in block 1624. If the start date of the successor begins before the end date of the current activity, the processor may receive a command via the GUI to set a new start date to the successor in order to match it to the new end date of the current activity, as indicated in block 1626. That is, the successor may receive a new start date that begins later than initially appearing on the project plan. In conclusion, the activity duration is changed, as indicated in block 1630.

FIG. 16B may illustrate method 1660, which may include a processor receiving a command, via the GUI, to create an end-to-start link between a first activity and a second activity, as indicated in block 1662. The processor may determine whether the end date of the first activity is later in time as compared to the start date of the second activity, as indicated in block 1664. The processor may then receive a command via the GUI to move the start date of the second activity to match the end date of the first activity, as indicated in block 1666. Thus, the duration of the second activity is changed, as indicated in block 1670.

According to some embodiments, a processor may receive a command via the GUI to add a new activity, whereas a new activity may only be added on an empty grid. If there is no open space along the grip for adding a new activity, the processor may receive a command via the GUI to move one or more existing activities or to open a new AOA or new sub-AOA.

According to some embodiments, links between activities set on the same sub-AOA or on the same AOA are created automatically. That is, these links are simple end-to-start links connecting between the end date of one activity to the start date of a successor activity. Such simple links may be created in all optional layers of the project management plan.

In some embodiments, links between activities of different sub-AOAs or different AOAs, may be created manually. A processor may receive a command via the GUI to add such links between different sub-AOAs of between different AOAs. These links are also typically end-to-start links. According to some embodiments, such links may be created only in a weekly time scale. However, in other embodiments, such links may be created in other time scales, e.g., month, year, quarter, and so on.

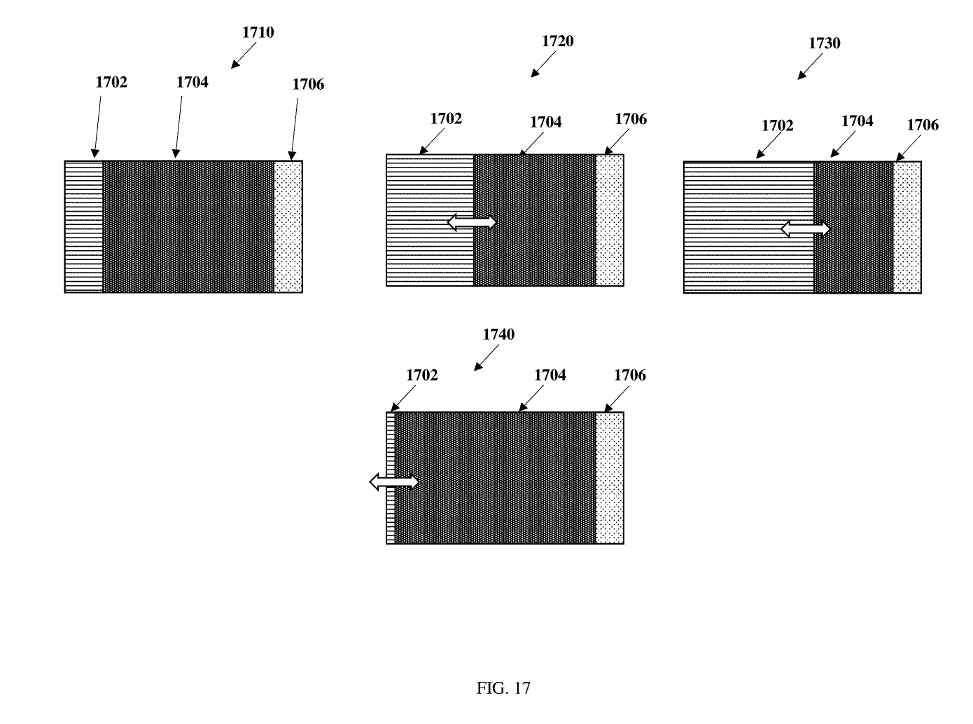

Reference is now made to FIG. 17, which schematically illustrates different expansion states of the user interface, according to embodiments of the present invention. In some embodiments, since the screen onto which a GUI is displayed, is limited in space at least by the physical boundaries of the screen. Thus, a dynamic display is required. The dynamic display may enable a user to select which of the areas of the screen would be displayed larger than other areas, or larger with respect to the area's initial display size, in order to enable better view of that area, as well as to enable to view additional details that might be invisible when that displayed area is small.

In some embodiments, GUI 1710 may be defined as a default display. In this default display area 1704 may be the largest displayed area, while areas 1702 and 1706 are substantially smaller in size as compared to the size of area 1704. A processor may then receive a command via the GUI to increase the size of area 1702. Thus, as indicated by GUI 1720, area 1702 may be increased, to what may be defined as medium size. Since, as mentioned above, the total display size is limited by the size of the screen the GUI is displayed on, once the size of area 1702 is increased, the size of area 1704 is required to be decreased. The amount of decrease in area 1704 is equivalent to the amount of increase in size of area 1702. In some embodiments, the size of area 1706 may also be affected by the changes in sizes of corresponding areas 1702 and 1704. That is, the size of area 1706 may increase or decrease with respect to changes in sizes of its corresponding areas 1702 and 1704.

According to GUI 1730, if a processor receives a command via the GUI to further increase the size of area 1702, the size of area 1702 may be increased to what is indicated as large size. Accordingly, the size of area 1704 (and possibly the size of area 1706) may decrease in the same amount as the amount of increase in area 1702.

In some embodiments, GUI 1740 may indicate a minimized size of area 1702, in which case a processor received a command via the GUI to increase the size of area 1704 on the account of the size of area 1702. Any other changes in sizes of any of the areas is possible, as long as the amount of increase to any of the areas is equivalent to the amount of decrease in any of the other corresponding areas, such that the total size of the GUI is kept the same.

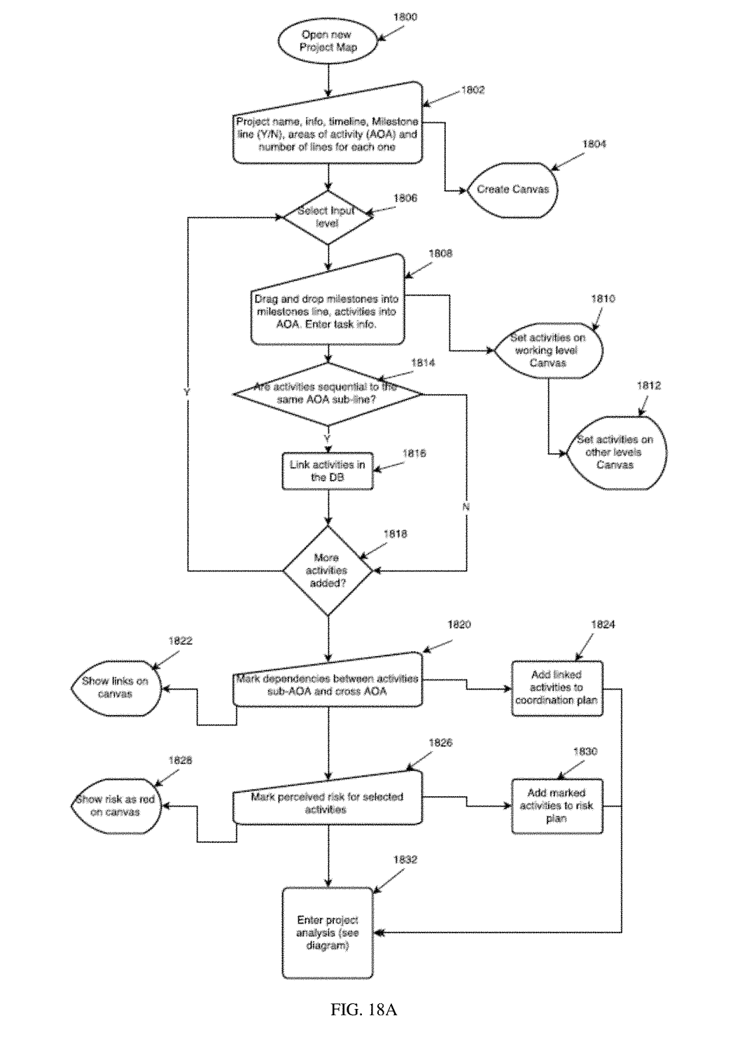

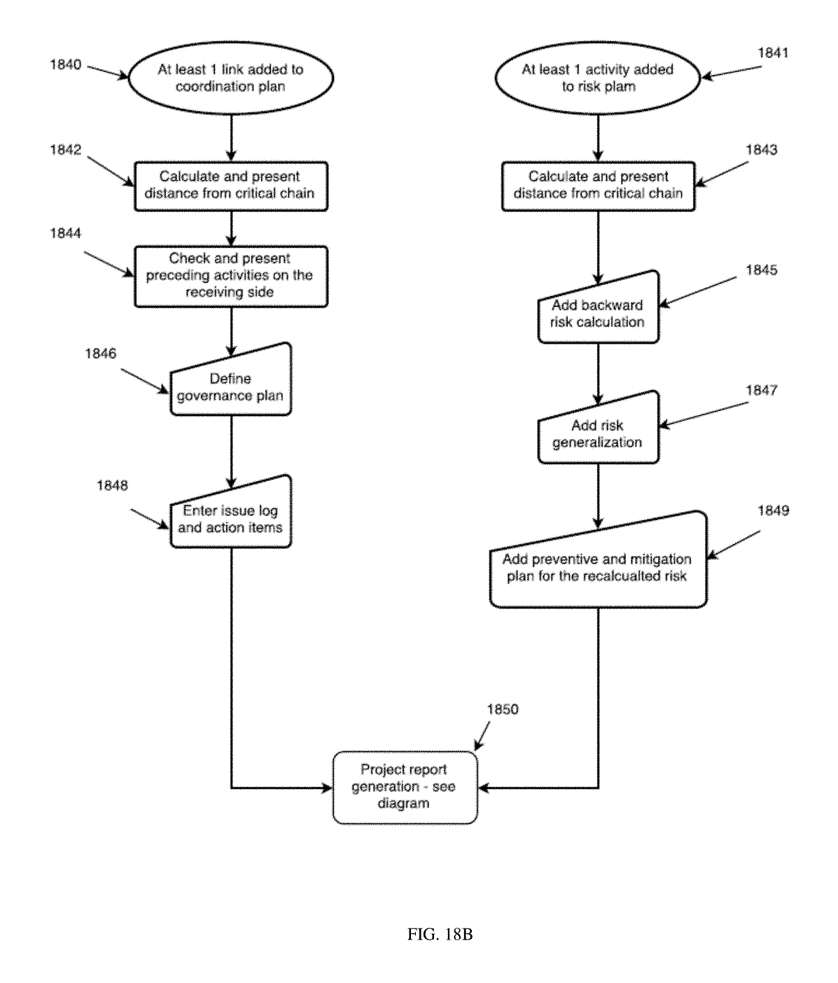

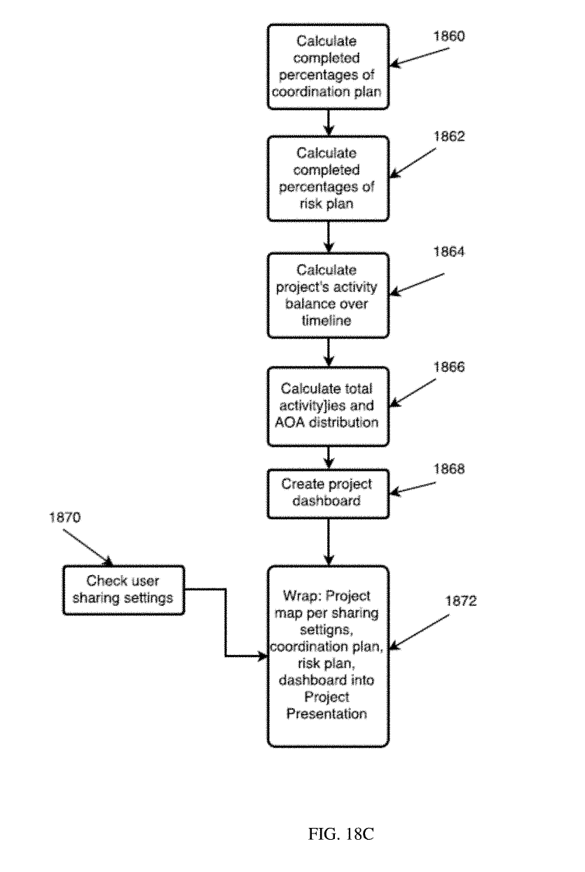

FIGS. 18A-18C schematically illustrate methods for generating and displaying a project action plan, according to exemplary embodiments of the disclosed subject matter. Reference is now made to FIG. 18A, which schematically illustrates a method for obtaining a collection of data for generating the project action plan, according to exemplary embodiments of the disclosed subject matter. Step 1800 discloses the server 110 generating a new project map. A new project map provides the user with an empty planning canvas, ability to drag and drop milestones and activities into it, creating dependencies and mark perceived risk. It also enables setup of canvas view options, like marking the critical chain, adding “today” line, show/hide dependencies, etc.

Step 1802 discloses the server 110 obtains project identifying information, such as a project name, company name, project type, expected project start/end date, or the like. In addition, step 1802 asks the user to define upfront the projects “Area of Activity (AoA)” and optionally suggest an inclusion of “Milestone Line”. “Area of Activity”, “sub-Area of Activity” and “Milestone line” can be edited as part of steps 1806-1818. “Areas of Activity” are different functional areas in which the projects activities are expected to take place. “Sub Area of Activity” represents several different functional areas within one “Area of Activity”. “Milestone line” is where projects' milestones can be marked. Milestones have no duration and are used to create dependencies to activities. The completion of these activities will define the project milestone target date.

Step 1804 discloses the server 110 generates a canvas. The server 110 is using the information provided in step 1802 to generate the canvas. In some embodiments, the “Areas of Activity” are displayed on the “Y” axis of the diagram. In some embodiments, the expected start/end date defines the timeline displayed on the “X” axis of the diagram. Once the canvas is generated, new milestones and activities added with step 1808 are mapped into Areas of Activity and are set on the timeline.

Step 1806 discloses the server 110 obtaining a selection of an input level, for example, a daily input level, a weekly input level, a monthly input level, a yearly input level, or the like.

Step 1808 discloses the server 110 receiving a command to drag and drop milestones onto the milestone line, drag activities into areas of activities, or the like. The milestones and/or activities added to the canvas represent the project knowledge, activity sequences, duration, dependencies and risk as known to the project manager and the project team at the time of the planning session. When adding new activity, the user must define the activity name/description in the level of details selected in step 1806. The user can optionally define also the activity name/description to be displayed when other level of details is selected.

Step 1810 discloses the server 110 displays selected activities on a designated working level canvas.

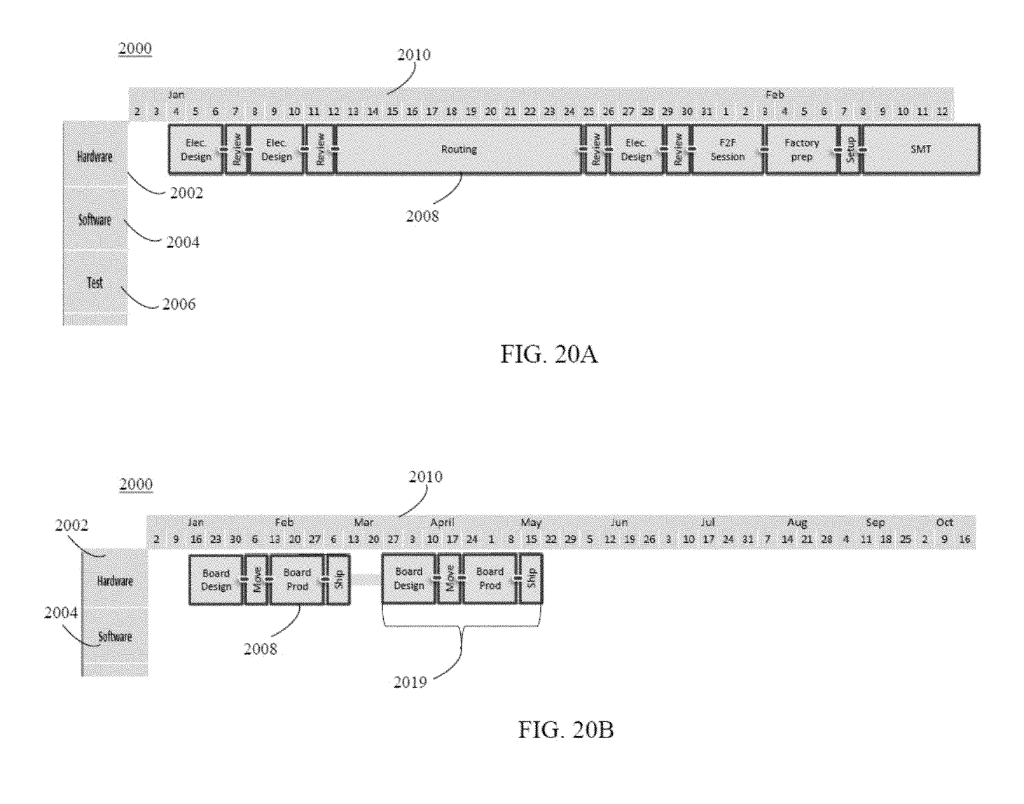

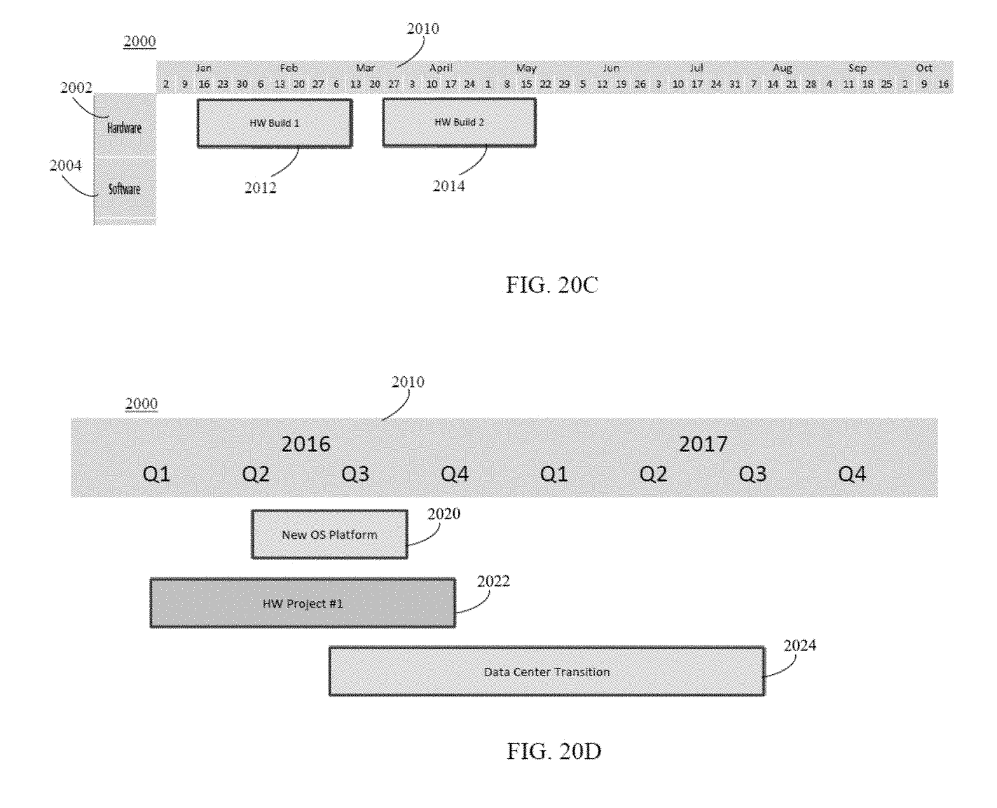

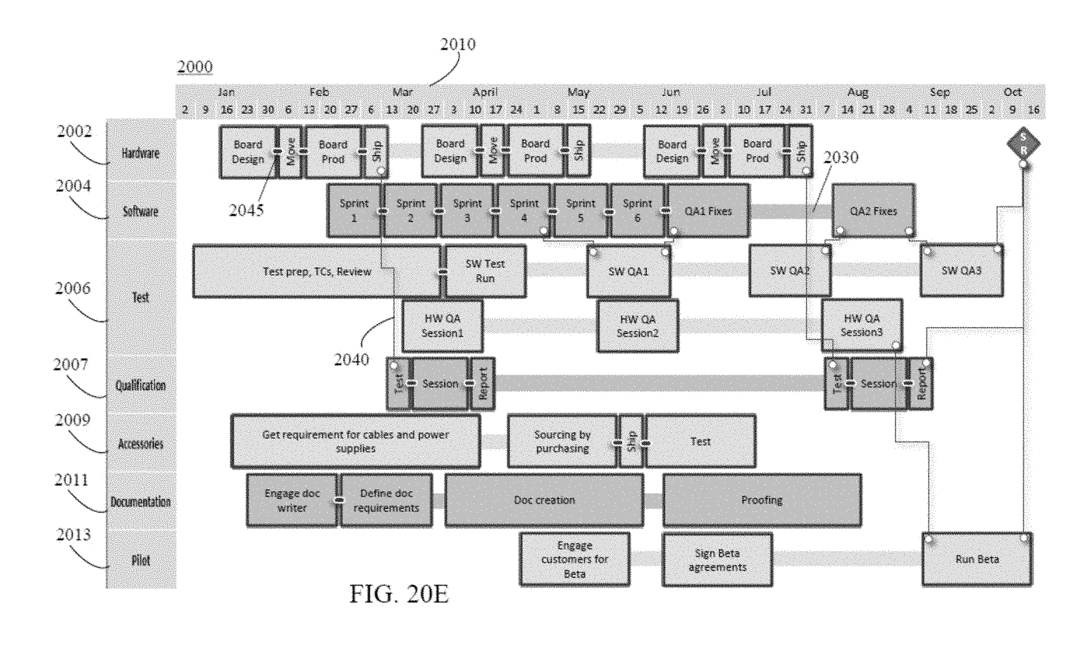

Step 1812 discloses the server 110 inserts the selected activities to other levels of the canvas based on information provided in step 1808. For example, the activity “Board Design” in the Weekly level is captured with an attribute input by the user, stating parent activity “HW Build 1” in Monthly level. If the user will move to monthly view 400 (FIGS. 20A-20E) the Monthly title will show.

Step 1814 discloses the server 110 determining whether activities which were designated in a sequential manner by the user, are associated with the same area of activity.

If it is determined that the activities are designated in a sequential manner, the server 110 performs step 1816 that provides dependency between these activities in the database. Dependent activities (e.g., beginning of an activity is dependent upon end of another activity or alike) create activities chain, which with other chains enable the calculation and presentation of the project expected completion date.

Step 1818 discloses the server 110 waiting for more activities to be added by the user till the point that the user decides to move to step 1820. The user can go back to steps 1806-1818 thereby adding more milestones and activities even after moving down the process flow.

Step 1820 discloses the server 110 capturing dependencies marked by the user between activities in different sub-areas of activities and between areas of activity according to received commands. For example, step 1820 may capture dependency marked by the user between activities of sub Areas of Activity, for example, “HW test” and “SW test” within Area of Activity “Test”. It may also capture dependency between activities in different areas of activity, for example, it may capture a dependency between activities in Area of Activity “Test” and activities in other Area of Activity “Production”.

Step 1822 discloses the server 110 displaying links between activities on the canvas according to the marked dependencies.

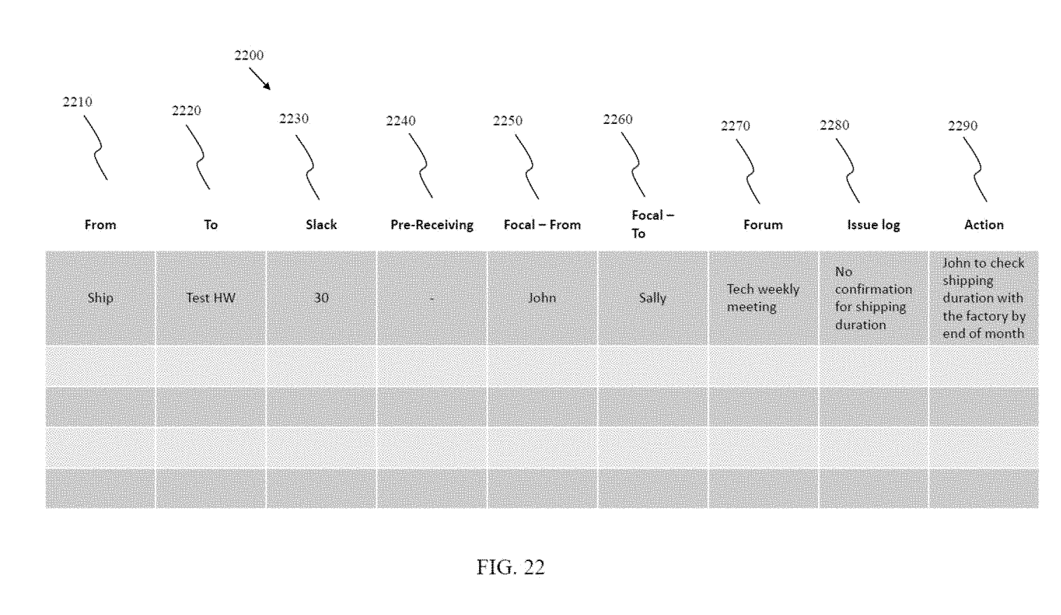

Step 1824 discloses the server 110 adding linked activities as captured in 1820 into a coordination plan. The coordination plan is a list of dependent activities as defined in 1820 with appropriate coordination activity defined and illustrated in FIG. 22. This coordination plan is considered to cover the project critical dependencies as it represents dependencies between functional areas of activity. Dependencies within the same sub area of activity, such as captured in 1816 are considered out of coordination plan scope. A coordination plan has at least two priority levels. A first Priority level may include dependencies between areas of activity where the perceived expected miss-coordination is most probable. A second priority level may include dependencies between sub area of activity where miss-coordination is considered less probable. Additional priority levels may be used.

Step 1826 discloses the server 110 marking perceived risks for selected areas of activities. Activities that are marked with perceived risk are considered risky by the user, e.g., activities marked with perceived risk are considered as high risk activities. For example, vendor with bad reputation, activities where the organization has less knowledge, activities which were delayed in past projects. Perceived risk (as opposed to calculated risk in prior art applications) is defined by the user's experience and according to the knowledge of the project's team.

Step 1828 discloses the server 110 displaying risks as a predetermined marking on the canvas, for example, by highlighting the risks on the canvas, e.g., by using bold font, or using a color that typically stands out, e.g., using a red outline for a specific activity marked as risk.

Step 1830 discloses the server 110 adding marked activities to the risk plan as in FIG. 13.

Step 1832 discloses the server 110 capturing minimum amount of data and can perform a project analysis, as provided by the method described in FIG. 18B. At least one dependency between sub Areas of Activity is required to start Coordination plan 1840 (FIG. 18B). At least one activity marked as risk is required to start Risk Plan 1841. The steps described in FIGS. 18A and 18B can be repeated several times before the project plan and action plan are ready.

Reference is now made to FIG. 18B, which schematically illustrates a method for analysis of the collection data for generating the project presentation report illustrated in FIG. 18C, according to exemplary embodiments of the disclosed subject matter. Step 1840 discloses the server 110 receiving at least one dependency to be added to the coordination plan thereby beginning the Coordination plan. An example of a Coordination plan is illustrated in FIG. 22. For example, dependency is represented by the delivering side “From” 2210 and the receiving side “To” 2220.

Step 1842 discloses the server 110 calculating and providing distance from critical chains, e.g. chain 630 (FIG. 22). The critical chain is the shortest route to the end of the project, which may be calculated based on activities duration and dependencies between activities. The slack 1320 (FIG. 13) is the distance (in days) between the dependent activity to the critical chain. It represents the number of days the activity can be delayed before pushing project completion date to a different delayed date. Slack=0 means activity on the critical chain.

Step 1844 discloses the server 110 checking and presenting preceding activities on a receiving side, e.g., pre-receiving 2240. This data item gives an indication of the level of readiness and preparation done to be ready for the expected dependency on the receiving side.

Step 1846 discloses the user defining a governance plan. Governance plan may include at least: responsible owner on the delivering side of the dependency, e.g., ‘Focal-From’ 2250, responsible owner of the receiving side of the dependency, e.g., ‘Focal-To’ 2260, forum/meeting in which the dependency readiness is tracked, e.g., Forum 2270.

Step 1848 discloses the user entering an issue log, e.g., “Issue log” 2280 and action items, e.g., “Action plan” 2290. “Issue log” is the list of open issues being handled to secure the dependency. “Action plan” is the list of actions being tracked to secure the dependency.

Step 1841 discloses the server 110 receiving at least one activity to be added to the risk plan by the user. As long as no activities are marked as perceived risk, the Risk Plan creation cannot begin. An example for a Risk Plan is illustrated in FIG. 13, where the activity defined as risky is activity 1310, which is a “HWTtest”.

Step 1843 discloses the server 110 calculating and providing distance from critical chains, e.g., Slack 1320. The critical chain is the shortest route to the end of the project and is calculated based on activities duration and dependencies between activities. The slack is the distance (in days) between the activity marked with risk to the critical chain. It represents the number of days the activity can be delayed before pushing project completion to a future date. Slack=0 means activity on the critical chain.

Step 1845 discloses the user manually adding a backward risk calculation, e.g., “Backward Risk Calculation” 1330. “Backward risk calculation” is the preceding step that preventing it may block access to the defined risk. For example, if we defined “HW failure after shipment” as risk, we will define “HW test in the factory” as Backward risk calculation and refer to it in our preventive and mitigation plan 1849. By preventing any issue with “HW test in the factory” we may likely never need to address the “HW failure after shipment”.

Step 1847 discloses the server 110 adding a risk generalization, e.g., Generalization 1340. Risk generalization is additional activities in the same project suffering from the same risk. For example, if “HW failure after shipment” is defined as risk for HW cycle one, risk generalization will indicate all HW shipments from the factory in that analysis such that HW cycles two, three, etc. will be included.

Step 1849 discloses the user manually adding a preventive, e.g., “Preventive” 1350 and “Mitigation” plan 1360 for the re-calculated risk. Preventive plan includes the actions that are done in order to avoid the risk. Mitigation plan includes the actions one may do in case of risk materialization, in order to reduce the risk's impact on the plan. For example, if the risk is “HW test in the factory”, a preventive action may be writing a detailed test plan for the factory, and a Mitigation plan might be a random check at the shipping deck to find test escapees.

Step 1850 discloses the server 110 generating a project report as disclosed in FIG. 18C.

Reference is now made to FIG. 18C, which schematically illustrates a method for generating project report according to the analysis of the collection data obtained, according to exemplary embodiments of the disclosed subject matter.

Step 1860 discloses the server 110 calculating a completed percentage of the coordination plan. For examples, the server will count the Coordination Plan table empty cells against the total number of cells, where no empty cells means 100% complete.

Step 1862 discloses the server 110 calculating a completed percentage of risk plan. For examples, the server will count the Risk Plan table empty cells against the total number of cells, where no empty cells means 100% complete.

Step 1864 discloses the server 110 calculating project's activity balance over the timeline. For example, the server will divide the project horizon into three periods and count the number of activities in each one, then compare it to the company (configurable) target. If the company like to have balanced plan, it means 33% of activities in each period. The company may decide on higher target in the short term or a like.

Step 1866 discloses the server 110 calculating a total activities and area of activities distribution. For example, the server will count activity per Area of Activity or Sub Area of Activity and present the statistics as part of the project plan presentation. The user (or his managers/counterparts) can then gauge the amount of activities (represents the plan level of details) against their expectations or against company goal.

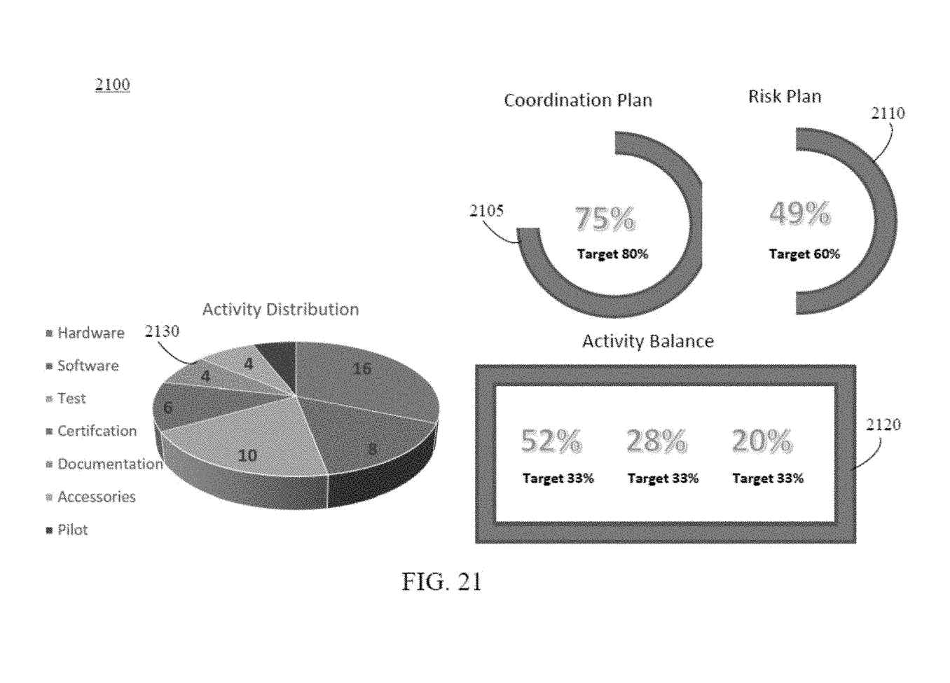

Step 1868 discloses the server 110 generating a project dashboard. Project dashboard will include all the statistics calculated for the project, including but not limited to 2105, 2110, 2120 and 2130 (FIG. 21).

Step 1870 discloses the server 110 check user sharing settings. The user can configure the shared data, for example, the layers that are included in the project report presentation, budget y/n, resources y/n, etc.

Step 1872 discloses the server 110 wrapping the project report into a project presentation. In this process the Project Plan, the Coordination Plan and the Risk Plan alongside the dashboard are wrapped into one sharable object. The object then allows navigation between level of details, action plan review and statistic review.

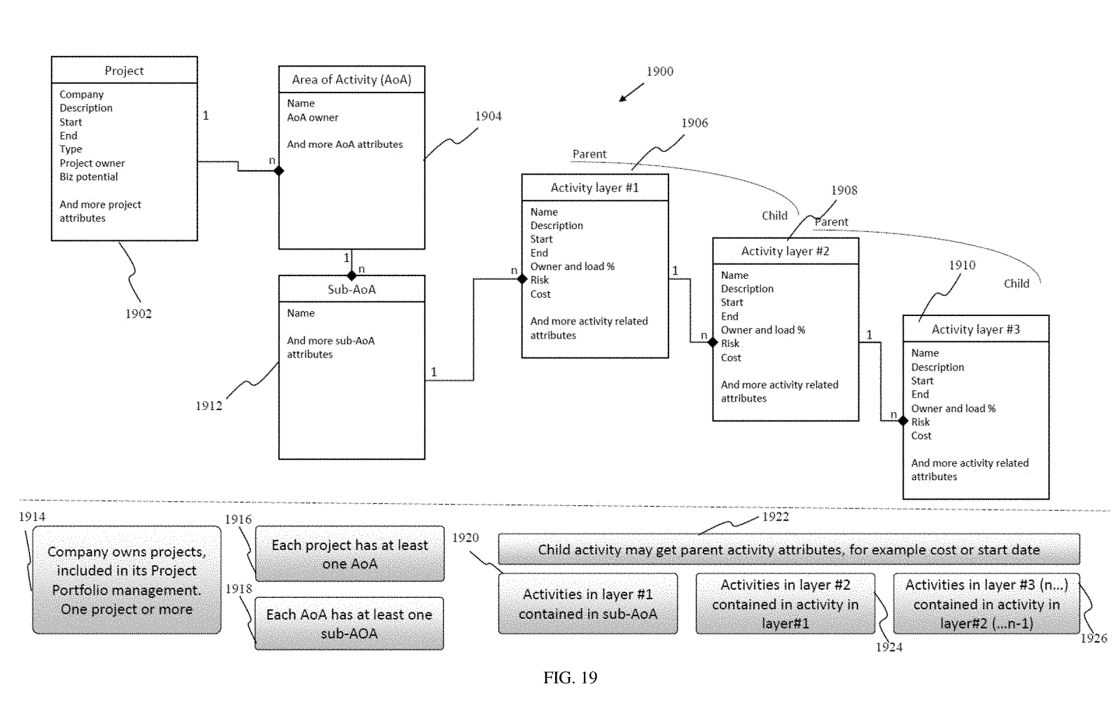

FIG. 19 schematically shows a project map data structure, according to some exemplary embodiments of the subject matter.

For each project 1902, the invention is using a unique data structure where “Area of Activity” (“AoA”) 1904 and “Sub-Area of Activity” 1912 are defined ahead of the activities themselves (1906-1908-1910) in one-to-many relationship. The activities are organized in at least three level of details which are also one-to-many inside any Sub-AoA (1906-1908-1910).

This structure allows building a unique project presentation in which each task is hierarchically assigned to both AoA and to specific level of details. In addition, it later on allows creation of unique project presentations and navigation between level of details within the same AoA (as in FIGS. 20A-20E). ProjectMap is using AoA as the mandatory head of the data structure hierarchy.

Prior art charts are using hierarchical task structure identified by task ID. This structure starts from high level tasks and can go down into low level tasks with layers in between. In theory a user of any hierarchical tool can build a set of tasks below higher level tasks OR build a set of tasks below AoA (captured as task description)—but these tools are not enforcing this data structure hence can't use the captured data as in this invention.

FIGS. 20A-20E schematically show a user interface displaying a graphic representing of a project action plan, according to some exemplary embodiments of the subject matter. FIG. 20A schematically shows the user interface displaying a graphic representing of a project action plan using a timeline view of days of a month, according to some exemplary embodiments of the subject matter. The user interface display 2000 may show areas of activity such as a hardware area 2002, software area 2004, and test area 2006. The user interface display 2000 displays a timeline 2010 and a list of high-level activities 2008, such as electronic design phase, review phase, etc. The user interface display 2000 shows the activities 2008 on a daily timeline view which presents what activities and tasks are performed on a weekly basis. Similarly, activities and areas of activity may be shown using a daily view, a monthly view, etc., for example as configured by a user of the project action plan application.

FIG. 20B schematically shows the user interface displaying a graphic representing of the project action plan in a weekly view, according to some exemplary embodiments of the subject matter. Actions that are shown in a higher level of detail in the weekly view of FIG. 20A, are aggregated into a weekly view in FIG. 20B. For example, the activities related to Board design are summarized into a single ‘Board Design’ activity 2019.

FIG. 20C schematically shows the user interface displaying a graphic representing of the project report in a resolution of a week but at a level of less details as compared to FIG. 20B, according to some exemplary embodiments of the subject matter. The user interface display 2000 may show the resolution on a weekly basis, showing activities in a higher level than in FIG. 20B, such as “HW Build 1” 2012 and “HW Build 2” 2014. The display enables managing the project on a weekly basis but on a higher level, e.g., containing less details per activity. The timeline 2010 is displayed to show a weekly scale.

FIG. 20D schematically shows the user interface displaying a graphic representation of the project action plan in a project portfolio management view, according to some exemplary embodiments of the subject matter.

FIG. 20E schematically shows the user interface displaying a graphic representation of the project plan using a view that details several Areas of Activity (AoA), according to some exemplary embodiments of the subject matter. For example, information AoA detailed may be “hardware” 2002, “software” 2004, “test” 2006, “qualification” 2007, “accessories” 2009, “documentation” 2011, “pilot” 2013, or the like. Activities connected together in the same AoA are connected by connection lines 2045. Activities from different AoA or Sub-AoA may be connected using connection lines 2040. Activities in the same AoA or Sub-AoA are connected by a time span connection line 2030 if not linked end-to-start as in 2045. FIG. 20E is showing the project plan in “Weekly” layer. Similar plan can be presented in other level of details as explained in FIGS. 20A-20C. Other project plan presentation maps can include several level of details within the same display, for example showing weekly activities within their parent monthly activity or any other layer combination.

FIG. 21 schematically shows a user interface displaying a project report statistics representation, according to some exemplary embodiments of the subject matter. The user interface display 2100 may display to a user statistics related to the project, such as a coordination plan 2105, a risk plan 2110, an activity balance 2120, and activity distribution 2130. The statistics displayed enable the user to know details related to the project and how to improve the project plan performance according to the statistics hence increase the confidence in the overall plan.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A computer-implemented method for dynamically updating and displaying project management plan via a graphical user interface (GUI), the method comprising:
receiving via the GUI an indication regarding a project management granularity to be updated, said granularity is selected from at least three different levels of detail presented to the user by the GUI, wherein each of the levels is linked to a respective database;
receiving a command via the GUI to add at least one activity in a time-slot in the indicated granularity;
storing said at least one activity in the database respective to said indicated project management granularity; and
displaying by the GUI, on a screen of a computerized device, the project management plan in a layered configuration according to areas of activity along a timeline, wherein each layer of display denotes one of said project management levels of detail, thereby displaying said added at least one activity in the layer corresponding to the indicated granularity.

2. The method according to claim 1, wherein if the indicated granularity is not the smallest, the method comprises updating at least one database corresponding, to a smaller granularity level according to the added activity.

3. The method according to claim 2, comprising displaying said at least one added activity in at least one layer corresponding to a smaller granularity.

4. The method according to claim 1, wherein said project management levels of detail comprise at least one of: Details, Planning, and High-level.

5. The method according to claim 1, wherein activities include information selected from: activity name, activity description, start and end time, cost, person assigned to accomplish the activity, risk level, changing activity to a buffer activity, and any combination thereof.

6. The method according to claim 1, further comprising adding links between activities, such that between a first activity linked to a second activity, the second activity begins or ends once the first activity begins or ends.

7. The method according to claim 4, wherein said links are added between activities within the same area of activity, or between activities in different areas of activity.

8. The method according to claim 1, further comprising adding milestones along the timeline of the display.

9. The method according to claim 8, wherein milestones include information selected from: milestone name, milestone description, date, or any combination thereof.

10. The method according to claim 4, further comprising assigning risk levels to any of the activities of any of the project management levels of detail.

11. The method according to claim 1, wherein the method further comprises removing or updating activities in any of the project management levels of detail, thereby updating said corresponding activities or sub-activities in said other levels.

12. The method according to claim 1, wherein the timeline grid is configurable between days, weeks, months, yearly quarters, and years.

13. The method according to claim 1, wherein each of said layers of display includes all areas of activity relevant to the project management plan, thus providing a single screen display per each of said layers.

14. The method according to claim 1, further comprising generating and displaying a specific employee's view, configured to display activities per project along the timeline that the specific employee or a manager has indicated to be assigned to said employee.

15. The method according to claim 14, wherein the specific employee view includes information selected from: activity name, activity description, start and end time, costs, risk level, status of an activity, percentage of accomplishment of an activity, or any combination thereof.

16. A system for dynamically updating and displaying project management plan in a graphical user interface (GUI), said system comprising:
at least one computerized device comprising a screen and a GUI on the screen;
a plurality of databases, each linked to a respective different project management granularity; and
at least one processor configured to execute a code, said code comprising instructions for:
receiving via the GUI an indication regarding a project management granularity to be updated, said granularity is selected from at least three different levels of detail presented to the user by the GUI;
receiving a command via the GUI to add at least one activity in a time-slot in the indicated granularity;
storing said at least one activity in a database respective to said indicated project management granularity; and
displaying by the GUI, the project management plan in a layered configuration according to areas of activity along a timeline, wherein each layer of display denotes one of said project management levels of detail, thereby displaying said added at least one activity in the layer corresponding to the indicated granularity.

17. The system according to claim 16, wherein in case the indicated granularity is not the smallest, the code's instructions comprise updating at least one database respective to a smaller granularity according to the added activity.

18. A computer-implemented method for dynamically updating and displaying project management plan via a graphical user interface (GUI), the method comprising:
receiving via the GUI an indication regarding a project management granularity to be updated, said granularity is selected from at least three different levels of detail presented to the user by the GUI, wherein each of the levels of detail is linked to a respective database;
receiving a command via the GUI to add at least one link between at least two different activities in the indicated granularity, wherein each of said at least two activities relate to a different area of activity;
storing said at least one link in the database respective to said indicated project management granularity; and
displaying by the GUI, on a screen of a computerized device, a project management plan according to areas of activity along a timeline comprising at least one link between activities related to different areas of activities, thereby displaying at least one risk of the project management plan.

19. The method according to claim 1, further comprising calculating an engagement rate, wherein the engagement rate is calculated per a single activity, per activities under the same area of activity or per total activities under a single project.

20. The method according to claim 19, wherein the engagement rate is calculated based on indications received via the GUI regarding an employee's progress in accomplishing a single activity, activities under the same area of activity, or total activities under a single project.

21. The method according to claim 19, wherein the engagement rate is calculated based on analysis of message traffic per activity.

22. The method according to claim 17, further comprising calculating a confidence level per a single activity, per activities under the same area of activity, or per total activities under a single project.

23. The method according to claim 22, wherein the confidence level per a single activity, per activities under the same area of activity, or per total activities under a single project is calculated based on at least one of the number of links connected to a specific activity from the same area of activity or from different areas of activity, the way the links and risks are handled, the engagement rate, or the activity slack.

24. The method according to claim 23, wherein the confidence level is calculated based on big-data, collected from a significant amount of projects' structure, as captured in the central database.
